(19) United States
(12) Patent Application Publication
(10) Pub. No.: US 2024/0309831 A1
(43) Pub. Date: Sep. 19, 2024

(54) Bobbin-Form Solid Controlled and Filament Fed Hybrid Propulsion Methods for Space Vehicle Innovative Architectures

(71) Applicant: Michael Ressa, Triggiano (IT)

(72) Inventor: Michael Ressa, Triggiano (IT)

(21) Appl. No.: 18/480,471

(22) Filed: Oct. 3, 2023

Related U.S. Application Data
(60) Provisional application No. 63/413,134, filed on Oct. 4, 2022.

(51) Int. Cl. F02K 9/56; F02K 9/72; F02K 9/95; F02K 9/97

(52) U.S. Cl. CPC F02K 9/566; F02K 9/72; F02K 9/95; F02K 9/97

(57) ABSTRACT

A dual-mode use Solid Controlled and Hybrid Rocket Engine, in the form of a cord/filament, of variable length, and single or multiple diameters, or shapes, coaxially packaged or comprising at least one, or more, canister-built common use bobbin-propellant housing(s), and at least one, or more, common use rocket engine combustion chamber(s), control feeding(s), and safety feature hardware, for modular-interchangeable space vehicle architectures, built-in variable performance feature-ability, for novel general propulsion uses.

### CROSS-REFERENCE TO RELATED APPLICATIONS

The present Utility patent application claims priority benefit of the U.S. provisional application for patent Ser. No. 63/413,134, entitled “BOBBIN-FORM SOLID CONTROLLED AND FILAMENT FED HYBRID PROPULSION METHODS FOR SPACE VEHICLE INNOVATIVE ARCHITECTURES”, filed on 4 Oct. 2022 under 35 U.S.C. 119(e). The contents of this/these related patent application(s) is/are incorporated herein by reference for all purposes to the extent that such subject matter is not inconsistent herewith or limiting hereof.

### RELATED CO-PENDING U.S. PATENT APPLICATIONS

Not applicable.

### INCORPORATION BY REFERENCE OF SEQUENCE LISTING PROVIDED AS A TEXT FILE

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### BACKGROUND OF THE RELEVANT PRIOR ART

One or more embodiments of the invention generally relate to aerospace propulsion. More particularly, certain embodiments of the invention relate to propulsion for launcher/missile stages, upper-stages, general spacecraft propulsion, satellite maneuvering systems, deorbit, missile defense, etc.

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

A variety of practical chemical rocket engines exist presently representing the current state of the art available each with its own characteristic performance that make them desirable for a given mission. Their limitations are also reasonably well known with very little space available for small overall performance improvements. Liquid propulsion systems, having to employ relatively larger number of flow control components, are more complex and expensive than solid propulsion systems. The solid fuel rocket engine has the merit of simplicity, but once firing has started, combustion cannot be stopped; here intended as in a classical/standard motor assembly. Most liquid propellants provide higher specific impulse (Isp) than do solid propellants, may be throttled to control the thrust and be restarted, though the research made in new modern energetic solid materials advanced the state of the art such that for many space propulsion applications a new generation of solid propellant systems may be as reliable and less costly than liquid propellant ones. The inherent simplicity of new solid propulsion reduces the processing times and head count. Liquid propellant systems inherently require more complex processing procedures resulting in longer processing times and a larger work force. The processing component of cost, for new generation solids, is substantially less.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that alternative solid rocket motors inventions have in common is a mechanical movement of a solid grain, somehow necessary to achieve variable thrust capability. Under some circumstances it is also desirable to be able to shut down the solid rocket motor and thus terminate its thrust at any desired time. Once the solid fuel has been ignited it may normally burn until completely consumed. Prior art solid propulsion systems technology does not allow for random stop capability unless the motor becomes disabled and therefore not reusable. It has therefore been difficult to bring about such random stop operation and still be able to reuse or salvage the motor. The shutdown and restart capability for a solid propulsion system is an important safety consideration and allows for eventually precise thrust control; a feature useful for better vehicle energy management during orbit maneuvers.

Proposed motor extinguishment, restart methods, and variable thrust control, though none truly resolve the requirements necessary to allow for uses in small and large propulsion systems and general applications, including pulse operation, describe only single solutions. Other forms of controllable solid propulsion show the key ideas and progress behind said control features based on low performance electrically controllable solid propulsion. Furthermore, in regards instead to new generation solid propellant materials, that have enhanced performance and are easier to handle and less dangerous than current technologies, such materials are based on innovations in Metal-Organic Frameworks (MOFs), which are porous materials with high potential for use in a large variety of industrial applications for rocket and spacecraft propulsion. These materials may provide a greener and more economical propellant alternative to conventional methods.

In regards to conventional solid motor throttling, this emphasizes how the problem of throttling, for this class of propulsion systems, still interests the research. The most important characteristic that all of these alternative solid rocket motors inventions have in common is the mechanical movement of the solid grain, somehow necessary to achieve variable thrust capability. Under some circumstances there may be a need to be able to shut down the solid rocket motor and thus terminate its thrust at any desired time. Once the solid fuel has been ignited it may normally burn until completely consumed. Prior art solid propulsion systems technology does not allow for random stop capability unless the motor becomes disabled and therefore not reusable. It has therefore been difficult to bring about such random stop operation and still be able to reuse or salvage the motor. The shutdown and restart capability for a solid propulsion system is an important safety consideration and allows for eventually precise thrust control, a feature useful for better vehicle energy management during orbit maneuvers. Regarding typical motors extinguishment and restart methods, variable thrust control may be provided though none truly resolve the requirements necessary to allow for uses in small and large propulsion systems and general applications, including pulse operation.

In view of the foregoing, it is clear that traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an exemplary semi-exploded perspective view of a distinctive propellant coiled grains which forms a whole coiled propellant grain package comprising three different propellant cord diameters, in accordance with an embodiment of the present invention;

FIG. 2 is an illustration of an exemplary perspective view of coiled grains (solid cords) prior to final coaxial configuration packaging, in accordance with an embodiment of the present invention;

FIG. 2A is an illustration of an exemplary perspective cross-section view of a coiled solid propellant grains coaxially positioned, in accordance with an embodiment of the present invention;

FIG. 2B is an illustration of an exemplary downward motion principle of a coiled solid propellant cord during extraction from a vertically mounted housing, in accordance with an embodiment of the present invention;

FIG. 3 is a top view example of a cross-section of nine coaxially packaged propellant coils, in accordance with an embodiment of the present invention;

FIG. 4 is an overall longitudinal perspective semi-exploded view of a safety system component (SFT) for the propellant cord(s) feedthrough and flame combustion control, in accordance with an embodiment of the present invention;

FIG. 4A is a perspective cross-section view example of a feedthrough and safety system (SFT) for the propellant cord control feature, in accordance with an embodiment of the present invention;

FIG. 4B illustrates a top view cross-section of the safety system (SFT) shown in FIG. 4A, in accordance with an embodiment of the present invention;

FIG. 4C is an overall representative side-view of the controlled solid rocket engine component, comprising the primary and secondary (backup) safety feature, in accordance with an embodiment of the present invention;

FIG. 5 illustrates a longitudinal cross-section of the detail of a safety feature feed-through component (SFT or “Safety Plug”) shown in FIG. 4 or FIG. 4A, in accordance with an embodiment of the present invention;

FIG. 6 illustrates an example side overall view of a mounted low/high pressure solid-controlled rocket engine based on an exterior laser ignition system (heat), in accordance with an embodiment of the present invention;

FIG. 6A is an illustration of an exemplary Commercial-Off-The-Shelf (COTS) type of Extruder and drive wheels used for commercially available 3D printers, in accordance with an embodiment of the present invention;

FIG. 7 is an illustration of an exemplary SFT threaded component mounted on a combustion chamber top section for a rapid assembly procedure, in accordance with an embodiment of the present invention;

FIG. 8 is a prospective view of a coiled-type solid propellant cord packaging for CubeSat propulsion module applicability and a solid-controlled rocket engine, in accordance with an embodiment of the present invention;

FIG. 9 illustrates a cross-sectional view of dual use “Common Component” controlled coil-based solid propellant rocket engine conical-shaped combustion chamber, in accordance with an embodiment of the present invention;

FIG. 9A illustrates an exemplary 3D CAD drawing of a top sloped “Common Component” mounting structure, for feedthrough and ignition hardware support, in accordance with an embodiment of the present invention;

FIG. 9B is a CNC machined Common Component prototype in stainless steel based on the 3D work illustration shown in FIG. 9A, in accordance with an embodiment of the present invention;

FIG. 10 is a representative top view of a clustered assembly example of six canister-type housings architecture for spacecraft use, in accordance with an embodiment of the present invention;

FIG. 10A is a representative top view of a clustered assembly example of FIG. 10, showing a first example method for symmetrically connecting-coupling the canisters with the propulsion units, for staging purposes, in accordance with an embodiment of the present invention;

FIG. 10B is a representative top view of a clustered assembly example of FIG. 10A, showing a second example method for symmetrically connecting-coupling the canisters with the propulsion units, for staging purposes, in accordance with an embodiment of the present invention;

FIG. 10C is a representative top view of a clustered assembly example of FIG. 10A, showing a third example method for symmetrically connecting-coupling the canisters with the propulsion units, for staging purposes, in accordance with an embodiment of the present invention;

FIG. 11 illustrates an exemplary cylindrical shaped central structure spacecraft architecture having eight canister-type housings, with a human size figure for comparison, in accordance with an embodiment of the present invention;

FIG. 12 is a schematic size comparison example (same architecture solution) between a human figure and the eight canisters-type architecture of FIG. 11, in accordance with an embodiment of the present invention;

FIG. 13 is a representative top view example of a modular assembly Space Propulsion Tug, comprising different sized canisters, in accordance with an embodiment of the present invention;

FIG. 14 is a 3D CAD black & white prospective view of a center circular frame, formed by nine mounting or attachment “common hole-points”, in accordance with an embodiment of the present invention;

FIG. 15 is a representative top view example of a modular assembly Space Propulsion Tug with a centered-axis single propulsion unit mounted on a triangular structure frame, in accordance with a further embodiment of the present invention;

FIG. 16 is a representative top view of a clustered assembly example of six canisters for hybrid propulsion application, in accordance with an embodiment of the present invention;

FIG. 17 illustrates a top detailed view of the seven “common hole-points” center circular mounting frame of FIG. 13 or of FIG. 16 for different architecture purposes, in accordance with an embodiment of the present invention;

FIG. 18 is a black & white photo of a 3D printed prototype of a seven “common hole-points” center circular mounting frame and a first version prototype of hybrid propulsion engine, in accordance with an embodiment of the present invention;

FIG. 19 is a representative top view of a seven “common hole-points” center circular mounting frame with external optional reinforcement structure, in accordance with an embodiment of the present invention;

FIG. 20 illustrates a simple schematic of a common (dual) principal of operation of the invention for solid-controlled and hybrid propulsion, in accordance with an embodiment of the present invention;

FIG. 21 illustrates a cross-sectional view of a propulsion module straightforward design, in accordance with an embodiment of the present invention;

FIG. 22 shows a 3D printed prototype in PEEK material of a jack screw for the propulsion module High Test Peroxide (HTP) tank of FIG. 21, in accordance with an embodiment of the present invention;

FIG. 23 is a black & white photo of a first prototype of a multi-mode use new generation rocket engine (nozzle not shown) similar to the cross-section schematic shown in FIG. 9, in accordance with an embodiment of the present invention;

FIG. 24 illustrates a simple schematic prospective view of the essential elements necessary to form a solid-cord propellant canister-housing and related interior coil (or bobbin).

FIG. 25 illustrates six simple views of different possible useful example of fabrication forms for solid propellant cords, plastic filaments and bobbin-types, in accordance with an embodiment of the present invention; and

FIG. 26 is an illustrative example in the form of a simplistic perspective view of a Space Tug embodiment, with four canister-housings and a single axial thruster, the modular-interchangeable design of which may be used for SCRE or hybrid propulsion applications, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Space tug is a type of spacecraft used to generally transfer spaceborne cargo from one orbit to another orbit with different energy characteristics.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settled law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially“] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, the term ‘substantially’ is well recognized in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of Claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. § 112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be described in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” include the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, is generally intended to mean late-stage user(s) as opposed to early-stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of. or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising” And “contain” and variations of them-Such terms are open-ended and mean “including but not limited to”. When employed in the appended claims, this term does not foreclose additional structure or steps. Consider a claim that recites: “A memory controller comprising a system cache . . . .” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

All terms of exemplary language (e.g., including, without limitation, “such as”, “like”, “for example”, “for instance”, “similar to”, etc.) are not exclusive of any other, potentially, unrelated, types of examples; thus, implicitly mean “by way of example, and not limitation . . . ”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” and “consisting of” limits the scope of a claim to the specified elements or method steps, plus those that do not materially affect the basis and novel characteristic(s) of the claimed subject matter (see Norian Corp. v Stryker Corp., 363 F.3d 1321, 1331-32, 70 USPQ2d 1508, Fed. Cir. 2004). Moreover, for any claim of the present invention which claims an embodiment “consisting essentially of” or “consisting of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of,” where one of these three terms is used herein, the disclosed and claimed subject matter may include the use of either of the other two terms. Thus, in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Moreover, any claim limitation phrased in functional limitation terms covered by 35 USC § 112(6) (post AIA 112(f)) which has a preamble invoking the closed terms “consisting of,” or “consisting essentially of,” should be understood to mean that the corresponding structure(s) disclosed herein define the exact metes and bounds of what the so claimed invention embodiment(s) consists of, or consisting essentially of, to the exclusion of any other elements which do not materially affect the intended purpose of the so claimed embodiment(s).

Devices or system modules that are in at least general communication with each other need not be in continuous communication with each other, unless expressly specified otherwise. In addition, devices or system modules that are in at least general communication with each other may communicate directly or indirectly through one or more intermediaries. Moreover, it is understood that any system components described or named in any embodiment or claimed herein may be grouped or sub-grouped (and accordingly implicitly renamed) in any combination or sub-combination as those skilled in the art can imagine as suitable for the particular application, and still be within the scope and spirit of the claimed embodiments of the present invention. For an example of what this means, if the invention was a controller of a motor and a valve and the embodiments and claims articulated those components as being separately grouped and connected, applying the foregoing would mean that such an invention and claims would also implicitly cover the valve being grouped inside the motor and the controller being a remote controller with no direct physical connection to the motor or internalized valve, as such the claimed invention is contemplated to cover all ways of grouping and/or adding of intermediate components or systems that still substantially achieve the intended result of the invention.

A description of an embodiment with several components in communication with each other does not imply that all such components are required. On the contrary a variety of optional components is described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

In one embodiment of the present invention relates to unique stage architectures and general methods for use as “String Propulsion” (as may be commonly known) in the form of a solid propellant cord for innovative Controllable High Performance Green Solid Propellant Rocket Systems, optional plastic-filament forms for Hybrid Propulsion Coupling Feature Systems, coiled and packed as a spool (bobbin), or in sheet-rolled type formats, either independently or in combination for specific different forms and all sort of uses.

In some embodiments, the present invention addresses the various problems of solid rocket design feature-ability as a whole (thrust control, extinguishment and restart), methodically into one single, general design solution that embraces all necessary solutions for the deficiencies present in the prior art proposals. Accordingly, the present invention embraces the strengths of an extensive technology historical review and addresses and proposes different solutions to the mentioned weaknesses of the prior art. The present invention allows to design and manufacture new generation modular propulsion systems which may be useful for all satellite propulsion uses including a class of research spacecraft called nanosatellites (CubeSats), De-orbiting Kits, large or small size launch vehicle upper-stages, missile defense system applications, etc. It may incorporate the heritage from other technologies and proposed new generation of high specific impulse solid propellants and, accordingly, solves the previously mentioned solid propulsion problems in a simple, safe, reliable, and cost-efficient manner. In regards to Defense & Space uses, the new teachings and related applications allows for new generation, truly cost-effective small and large size envelope new propulsion solutions, and a pioneering vast market creation through spawned new uses.

In other embodiments, the present invention may present a near future (soon to emerge) pioneering technology. Started through careful applicability evaluation for launch vehicles focus area first, with appropriate hardware modification and certain degree of extension work, the new teachings given may consequently be implemented for new focus areas of spacecraft propulsion and space tugs. The invention is based on an ideal modular/common hardware design solution for the propulsion unit components, hence new required hardware which may allow for a single or optional dual-mode operation thruster, capable of variable performance, by easy substitution during its assembly process of the propellant type and sized used. A very important design feature which, accordingly, becomes readily available when a series of different mission requirements and/or increased thrust becomes a necessity.

The present invention may resolve the problems and disadvantages of the prior art by providing an advanced environmentally friendly solid rocket propulsion system designed to have an integrated and universal assembly construction that combines the simplicity and reliability of solid propulsion systems with the feature-ability that liquid propulsion systems offer, and facilitates weight reduction without sacrificing structural strength performance, allowing better system packaging.

In further embodiments, it is a primary object of the present invention to obtain new design solutions to address all previously described prior art problems by the use of a bobbin-based general design method. Therefore, it is an object of this invention to provide for a cord or string-shaped solid grain with a conveniently variable length (hence a coiled-type design) for all type of necessities, that may be used to provide an universal geometrical construction of a controllable solid rocket engine so as to obtain a thrust characteristic curve of any desired shape while, at the same time, by turning the above mentioned weight problems into a light weight propellant canister-type housing assembly design. In fact, the present invention proposes a cost-convenient technology which may achieve system propellant mass fraction value as high as approximately 97%, that is about 3% or less inert mass fraction, finert ≤0.03, with an optimum limit being roughly 97.5%.

It is another object of this invention to provide for a coupled Safety-Feedthrough (hereinafter SFT) component for the Controllable Solid Rocket Engine (hereinafter CSRE) that may be used as an integral part in said universal construction which allows for an incorporated safety mechanism, while simultaneously providing for a dual random-stop engine feature, and accordingly very useful for thrust characteristic curves of any desired shape.

It is still another object of this invention to provide said fixed Safety-Feedthrough (SFT) hardware for CSRE design that is capable of motor shutdown capability without disabling the motor at any point in time. This object of the invention is specially aimed for better safety performance, compared to current solid motors which once ignited may continue to burn until propellant exhaustion, without regard for subsequent events. The invention also has the same operational characteristics of multistage systems or required in-orbit multiple firings for accurate satellite orbit injections, etc.

It is a further object of the invention to be able to use standard propellants; yet it is more performance capable when a CSRE is designed accordingly based on a modern, new generation and high performance unique hypergolic solid/hybrid propellants (MOFs based) available from the Canadian company ACSYNAM, the “energetic partner” of the present inventor.

Important advantages attained through the use of a CSRE, designed in accordance with the present teaching, include reduced requirements insofar as reduced weight and costs of extra insulation material, not required inside the solid propellant housing assembly. Such advantage of the present invention is the fact that the propellant grain housing section does not require an internal layer of insulation in order to protect the case from exposure to the heat of combustion as it is done in classical solid motor design. The CSRE of the present invention must be “pictured”, in its simplistic principle of operation, in the same manner of a liquid rocket engine with the difference that, instead of being fed with a liquid propellant for its operation, it is fed by a solid propellant made into an appropriate cord, coiled, or also as a rolled flat-sheet (tape form) for higher thrusts designs, and with a controlled feeding mechanism which, for the cord principle of operation, may resemble that of a 3D printer.

In one embodiment of the present disclosure, such technology of high propellant mass fractions may lead to trade-off studies that aim to achieve various performance and reliability targets for future solid propulsion systems selection criteria for mission requirements. Furthermore, a solid propulsion system of this new assembly type offers economic advantages since existing types of solid motors have their limitations. In the context of space transportation systems, example for launcher upper stages, such economic advantages may be reaped from the weight gain in cargo capacity, also thanks to the higher values (in vacuum) of specific impulse of the superior solid propellant: up to Isp=325 s versus Isp=280-300 s for the best available orbital solid motors and Isp=257 s for electrically controllable solid propulsion.

To summarize, prior art solutions lack of a single universal solid propellant rocket design capable of achieving contemporarily minimum inert weight through a better compact packaging, variable thrust control, multiple start-stop-restart anytime on demand capability, incorporate an optional hybrid rocket propulsion coupling feature and/or a monopropellant (High Test Peroxide/HTP-based) rocket propulsion coupling feature, through a commonality design, and finally, cord-grain on-sight and/or long distance (in-flight) continuous video inspection. Basically a “one design fits all” type of propulsion engineering solution, still missing in current solid propulsion systems.

The present invention will now be described in detail with reference to embodiments thereof as illustrated in the accompanying drawings.

### Solid Propellant Cord Coaxial Packaging

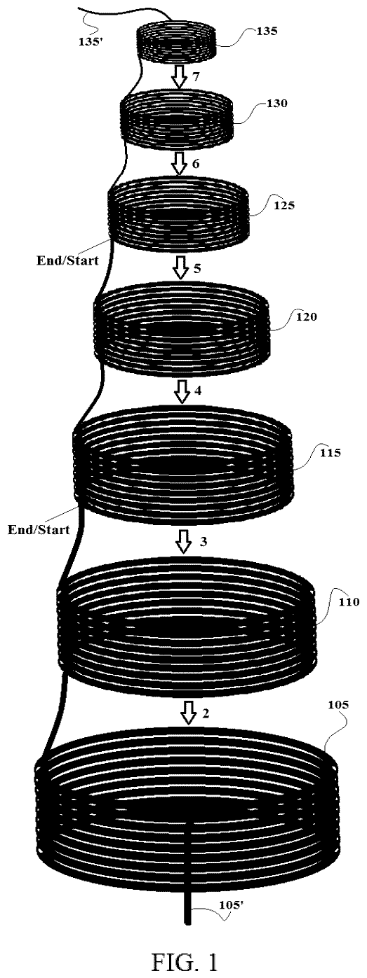

FIG. 1 is an exemplary semi-exploded perspective view of a distinctive propellant coiled grains which forms a whole coiled propellant grain package comprising, not a limitation, different propellant cord diameters, in accordance with an embodiment of the present invention. In one embodiment of the present invention, a propellant cord made of, not a limitation, seven sections and three different decreasing cord diameters is shown. Any sort of other variations may apply with a design and fabrication freedom only dictated by the necessary CSRE thrust range requirements and total burn time or required total impulse (Ns). In particular the cord example is made of a first coil 105 and a second coil 110, both having the same larger diameter with respect to the rest of the whole seven sections assembly. The beginning of the cord starts at its end feeder 105′ and part of first coil 105 while the other end, part of second coil 110, may be fabricated such that it is physically connected to the beginning of third coil section 3 (coil 115), thus forming a first END/START point shown in the figure. The same is valid for sections 4 (coil 120) also having the same diameter but slightly smaller than the first two coils. Accordingly, the same is valid for the remaining three last sections, 5 (coil 125), 6 (coil 130) and 7 (coil 135), all three having the same and smallest diameter and with last coil 135, which has an ending 135′. Decreasing cord diameters, as shown, allows for better final packaging and also smaller available thrust range, hence better, true high precision thrust control, due to a smaller propellant cord mass feeding of the remaining cord section.

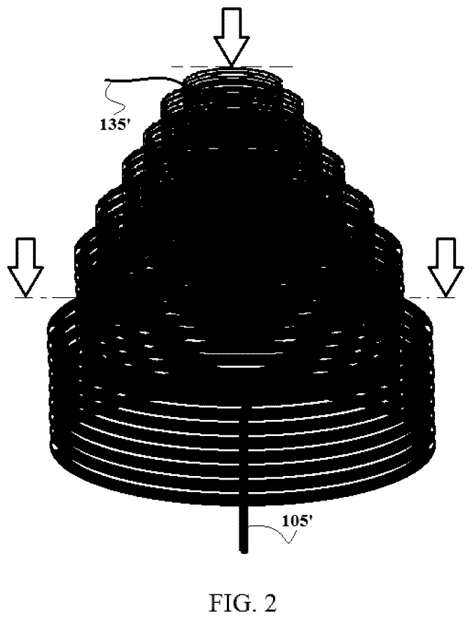

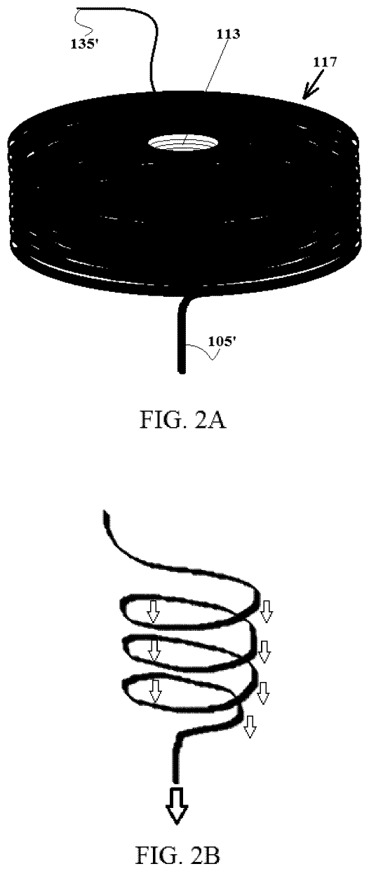

FIG. 2 is an illustration of an exemplary perspective view of coiled grains (solid cords) prior to final coaxial configuration packaging, in accordance with an embodiment of the present invention. FIG. 2 shows all the various coils which may be coaxially positioned to form a whole packaging shown in FIG. 2A. In FIG. 2, the arrow shows the top relative position of the smallest coil, having an end 135′ and prior to final axial assembling and/or positioning. The side bottom arrows show the top edge of the first larger coil and said end-feeder 105′ where the controlled combustion starts. The coaxially assembled whole compact final format is shown in FIG. 2A.

Any type of stack, assembled/prepared coil may also use a specific exterior light sticky coating which may offer an even better simple method to allow for sufficient practical stability of the coil package necessary for the launch environment and assurance of cord deployment for an appropriate and reliable unrolling of said cord. A simple schematic shown in FIG. 2B shows the movement of a cord in a downward motion in the vertical plane and which gives an idea of the unrolling mechanism of said cord package 117 of FIG. 2A in order of assembly. In summary, starts from coils 105, 110 having larger diameters, the first as the largest, and the unrolling and burning of which ends with the smaller diameter propellant cord 135.

FIG. 2A is an illustration of an exemplary perspective cross-section view of a coiled solid propellant grains coaxially positioned, in accordance with an embodiment of the present invention. FIG. 2A shows all the coils which may be coaxially positioned to form the whole packaging. The coaxially assembled whole compact final format coils pack 117 remains, accordingly, with only the two cord endings 105′ and 135′. The central-axially created cylindrical hole 113 may serve the purpose to hold a central “holding cylinder” (not shown) to prevent any movement of the whole cord package.

FIG. 2B is an illustration of an exemplary downward motion principle of a coiled solid propellant cord during extraction from a vertically mounted housing, in accordance with an embodiment of the present invention. A movement of a cord in a downward motion in the vertical plane is shown and which gives an idea of the unrolling mechanism of cord package 117 of FIG. 2A in order of assembly.

FIG. 3 is a top view example of a cross-section of nine coaxially packaged propellant coils, assembled with three decreasing cord diameters, made of three sets of three coils of the same cord diameters and decreasing lengths, in accordance with an embodiment of the present invention. A cross section of a slightly longer coil assembly is shown in FIG. 3, having a “3+3+3” END/START(s) that is formed with three different cord diameters, formed with nine coils, that is coil 105, 110, 115, 120, 125, 130, 135, 140, 145, end-feeder 105′, and ‘top-end” 145’. This method for coils assembling may become very useful to allow for the central “produced” hole to be used in a useful matter, for insertion of a single thruster, somewhat similar to the application of FIG. 21 (or FIG. 8 for CubeSats). The other method for propellant cord assembling is to adopt one identical to a CAT-5 cable (Reelex® packaging), which is also very reliable in its unrolling dynamics; hence a good method that may be applied to single and multiple diameter cords.

### Feedthrough and Safety Feature Component (SFT).

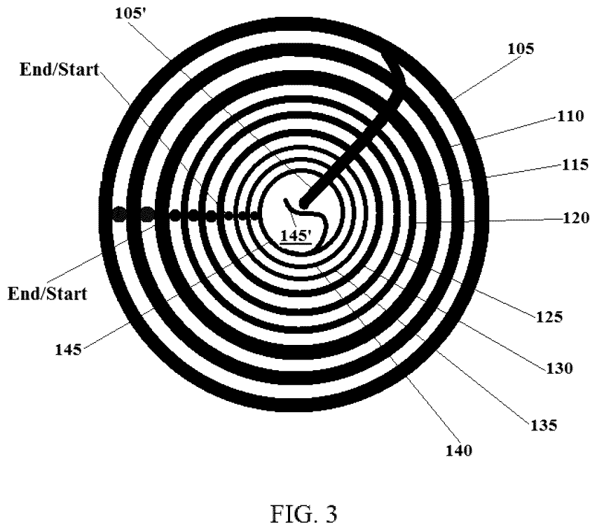

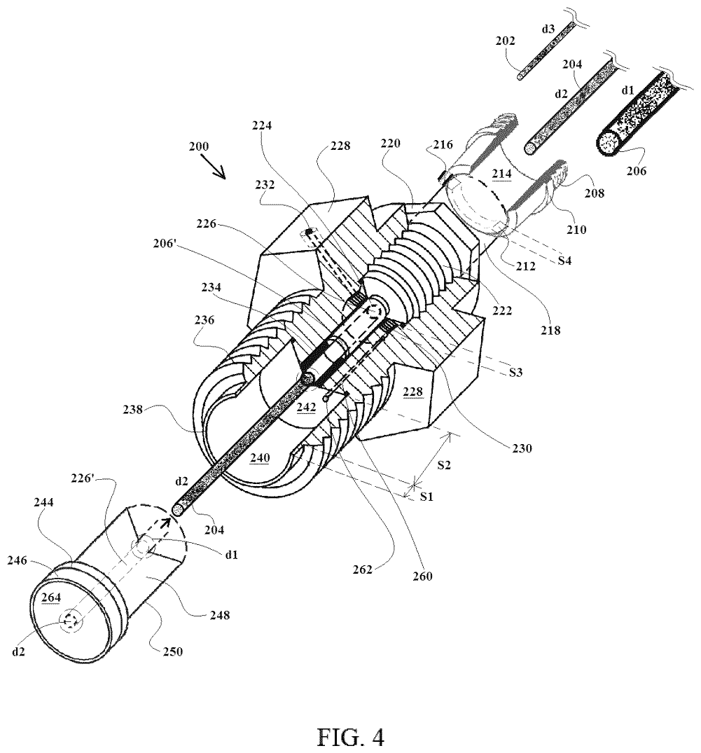

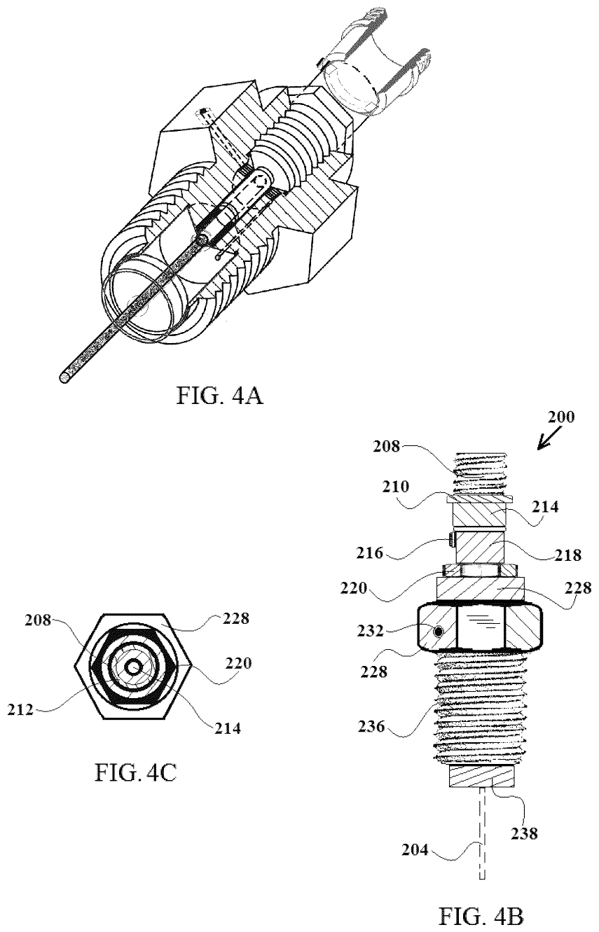

FIG. 4 is an overall longitudinal perspective semi-exploded view of the safety system component (SFT) 200 for the propellant cord feedthrough and flame combustion control, in accordance with an embodiment of the present invention. In one embodiment of the present invention, an overall longitudinal perspective semi-exploded view of the safety system component (SFT) for the propellant cord feedthrough and flame combustion control is shown. Composed of four safety sections S1, S2, S3 and S4, with the first two next to each other while the other two, S3 and S4, are spaced apart. The component 200 is ideally entirely manufactured by 3D printing technology. Suitable materials may be Carbon-PEEK, PEEK, Ceramic, etc.; ideally high temperature resistant and non-conducting materials. It is basically made of three main separate components which are fastly connected by the use of threads. The top section (the Feed-through) consists of one single part that may be designed through any CAD software and then 3D printed. Feedthrough 214, as shown, may include an inner cylindrical space, with also a cylindrical external wall which ends with a “Stop-Ring” 210 of which a first thread 208 may be used for attachment with the solid propellant canister through a feeding-hose (not shown). For a better whole understanding, reference is made also to FIG. 4A, FIG. 4B, FIG. 4C. Features an optionable different cord diameters.

In some embodiments, at a base of inner cylindrical volume 214 there is an annular section 212 which basically consists of Safety Section S4, of which an inlet 216 may be attached to an outer gas-pressure valve (not shown). The small annular may also have several holes (not shown but obvious) to allow high pressure quenching gas to come out coaxially and towards the central cylinder axis, the solid propellant cord of which passes through. The high gas pressure, released on command, is sufficient to rapidly cut the small diameter propellant cord, when necessary. The feedthrough extends through the short length cylindrical wall 218 which is attached to the hexagonal-shaped part 220 and furtherly attached to the threaded section 222. The whole part basically ends with a plug (or tunnel) 224 made of a thin cylindrical wall 206′, having a smaller diameter versus sections 214 and thread 222, having in its entire longitudinal interior a soft sponge-type material 234, or also a soft silicon-based material, which allows for different cord diameters to be used, come out from hole 226 and move inside tunnels 224-226′. FIG. 4 shows an example of larger diameter d1 for cord 206 (1 cm or ½″), a cord 204 with a diameter d2 (e.g. 0.5 cm or ¼″, see also FIG. 4B), and cord 202 with a diameter d3 (e.g. 2-3 mm or ⅛″).

In other embodiments, at the base of the threaded section 222 a second high pressure quenching annular section 230, forming the safety section S3, completes the body elements which forms said first hardware cord-cutter component, hence S4 together with S3. The coaxially assembled second key hardware cord-cutter component, as shown (section S2 together with S1), is formed by the following elements and which may be 3D printed in its whole. Main body 228 is formed by a top section made of a bolt-shaped body and with an attached shorter cylindrical section, the one which is coaxially connected by thread 222. The whole is designated as element 228 (FIG. 4, FIG. 4B, FIG. 4C) of which a threaded section 236 (the third for the whole component 200) completes main body part 228. One of the side exterior surfaces forming the hexagonal part requires a threaded hole 232, for function as an inlet, which leads to the annular 230. This allows the passage for a pressurized quenching gas (or a quenching fluid) to feed said annular which is in direct connection with the inner side of plug/tube 206′. When the gas enters through inlet 232 the upper part of which, again, is opportunely threaded to allow connection with a control exterior valve (not shown). Not only this allows for a sufficient supply of gas/fluid in annular 230 (Safety Section S3) but also a thin boundary quenching layer along the longitudinal length of the inner part of plug 206′.

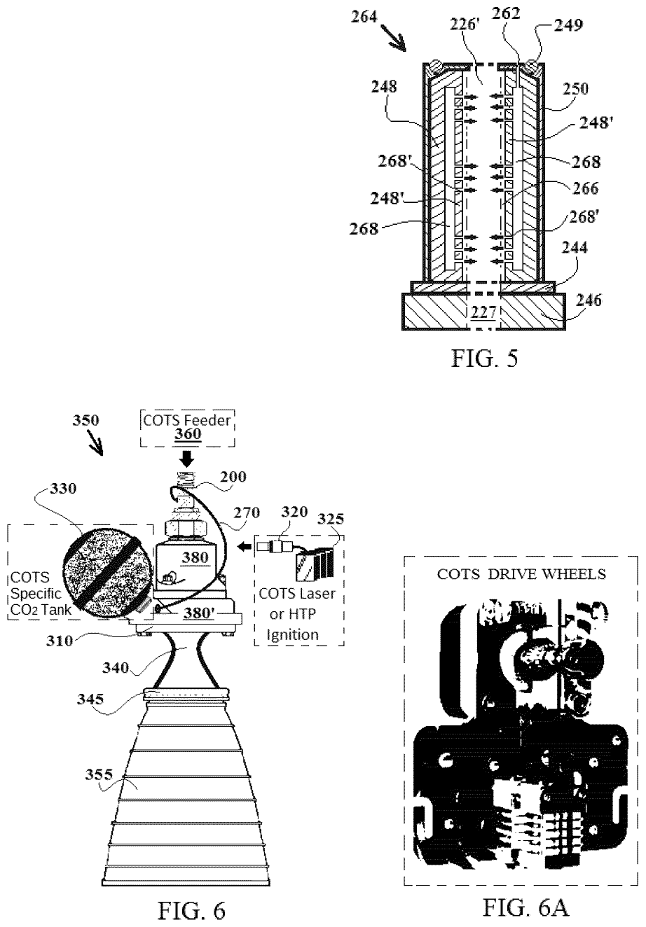

In other embodiments, more precisely, when a safety signal command opens said exterior valve, accordingly, a thin gas/fluid layer forms inside of plug/tube 206′, in case of temperature rise in between the propellant cord 204 and the coaxially surrounding layer of soft-guide material 234. Therefore, the scope is to cut and surround the cord and quench immediately any developing flame. The threaded section 236 ends with a cylindrical portion 238 forming an empty volume 240 with a base wall 242. This cylindrical volume 240 is the space necessary to attach the third main component 264, a secondary base plug which is made to create the Safety Sections S1 and S2 of the whole Safety Plug 200. The materials for the chamber cap plug 264 and cylindrical insertion section 250 (details illustrated in FIG. 5) may be a high temperature resistant material such as Inconel, Tungsten, Ceramic, etc. Must be inserted into the empty space section 240 and tightly touch end wall 242, with the help of O-ring 249. Attachment options are by thread or by welding though, ideally, a 3D printing as a whole part is preferred and advised. All options are admissible though it depends on the size of the rocket engine and its particular use. In reference to FIG. 4 and FIG. 5, plug 264 is formed by the centrally-axially hole 226′ of major diameter d1, but it may conserve the feature to be manufactured in different versions based on given diameters d1, d2, d3, etc. with, example, d2 shown in the figure. Its construction elements may include an exterior base cap 246, a connector part 244, said insert cylindrical section 250, an inner (specifically shaped) jet-cutter section 248, composed with a coaxially structure wall 248′ (FIG. 5) having said jet-cutters formed by a series of even distributed holes 268′ with in between a space or groove 268 where the quenching fluid or gas, coming from inlet 262, flows by. A thin layer of gas/fluid 266 is also formed between the cord section and the inner wall 248′. The solid propellant cord exits the Safety-Plug 264, from the exit hole 227, but also with a safety boundary layer 266 of gas or fluid which prevents combustion flames, generated by the solid propellant burning, to back up into hole 227 and thus into the cord-channel 226′. The gas/fluid supplied to the Safety-Plug 264 is done through the small conduct 260 (FIG. 4), from annular-ring section 230 and entering through the top hole connection 262. FIG. 4A shows a perspective whole view of the interior of safety plug-component 200 while an exterior side view is shown in FIG. 4B with its detailed parts. The top sectional view is instead shown in FIG. 4C with the essential viewable parts numerically identified and previously discussed. FIG. 4A and FIG. 4B show the exiting cords only. It is clear from the previous whole discussion that the cord enters from the top part.

FIG. 4A is a perspective cross-section view example of the feedthrough and safety system (SFT) for the propellant cord control feature, in accordance with an embodiment of the present invention. FIG. 4A shows a perspective whole view of the interior of safety plug-component 200 while an exterior side view is shown in FIG. 4B with its detailed parts. FIG. 4A and FIG. 4B show the exiting cords only. It is clear from the previous whole discussion that the cord enters from the top part.

FIG. 4B illustrates a top view cross-section of the safety system (SFT) shown in FIG. 4A, in accordance with an embodiment of the present invention. FIG. 4A and FIG. 4B show the exiting cords only.

FIG. 4C is an overall representative side-view of the controlled solid rocket engine component, comprising the primary and secondary (backup) safety features, in accordance with an embodiment of the present invention. FIG. 4C shows a top sectional view of the safety system component (SFT).

FIG. 5 illustrates a longitudinal cross-section of the detail of the safety feature feed-through component (SFT or “Safety Plug”) plug 264, in accordance with an embodiment of the present invention. In reference to FIG. 4 and FIG. 5, safety plug 264 is formed by the centrally-axially hole 226′ of major diameter d1, but it may conserve the feature to be manufactured in different versions based on given diameters d1, d2, d3, etc. with, example, d2 shown in the figure. Its construction elements may include an exterior base cap 246, a connector part 244, said insert cylindrical section 250, an inner (specifically shaped) jet-cutter section 248, composed with a coaxially structure wall 248′ (FIG. 5) having said jet-cutters formed by a series of even distributed holes 268′ with in between a space or groove 268 where the quenching fluid or gas, coming from inlet 262, flows by. A thin layer of gas/fluid 266 is also formed between the cord section and the inner wall 248′. The solid propellant cord exits the Safety-Plug 264, from the exit hole 227, but also with a safety boundary layer 266 of gas or fluid which prevents combustion flames, generated by the solid propellant burning, to back up into hole 227 and thus into the cord-channel 226′. The gas/fluid supplied to the Safety-Plug 264 is done through the small conduct 260 (FIG. 4), from annular-ring section 230 and entering through the top hole connection 262. Safety plug 264 comprises a set of grooves/coaxial empty space(s) 268, engraved and/or built-in parallel to at least one surface coaxially positioned with at least one solid propellant cord. SFTs may typically be 3D printed for better high quality and high precision manufacturing, allowing for accuracy in said grooves/space(s) 268, which are basically, in this embodiment, circular thin “micro chamber-type areas” which allow said jet-cutting feature.

FIG. 6 illustrates an example side overall view of a mounted low/high pressure solid-controlled rocket engine based on an exterior laser ignition system (heat), as an optional ignition feature, and an incorporated CO2 small pressurized tank for engine control purposes, in accordance with an embodiment of the present invention. FIG. 6 illustrates a CSRE simple schematic configuration 350 with a single entrance feeding comprising an attachable COTS drive wheel 360 (indicated by the top downward arrow) to the SFT component 200, also attached to the upper-centrally part of a cylindrical shaped combustion chamber 380 comprising an extended plate-body section for necessary attachment of hardware and other COTS equipment. As shown in the figure, this may consist of at least one high pressure COTS quenching gas or fluid tank 330, which may also include in the connecting part a solenoid valve (not shown), one or two quenching gas or fluid tubes 270 (one shown in the figure). CSRE configuration 350 shown in FIG. 6 may also include a COTS Trigger Laser 320 to ignite the solid propellant cord, through a COTS control unit 325. A base plate 310, with an attached upper section of nozzle 355, forming a throat section 340, may be bolted on to said chamber section 380 attachment plate 380′. Furthermore, a threaded connection 345 is useful to attach lower section (extended part) of nozzle 355 to complete rocket engine assembly 350. Finally, HTP for ignition may be used instead of the laser system (ignition method), accordingly being the solid propellant hypergolic, with an ignition delay of less than ten milliseconds.

FIG. 6A is an illustration of an exemplary Commercial-Off-The-Shelf (COTS) type of Extruder and drive wheels used for commercially available 3D printers, in accordance with an embodiment of the present invention. Many are available commercially and only minor modifications are required, intended to support slightly larger diameters passing-through cords, or plastic filaments in the case of hybrid applications. They may be contained in an appropriate housing (not shown) which may also be 3d printed. Said housing may always have an end threaded section to be directly attached to the SFT component 200. Details are not shown and are not required. It is clear from the description and understandable by anyone knowledgeable in the art.

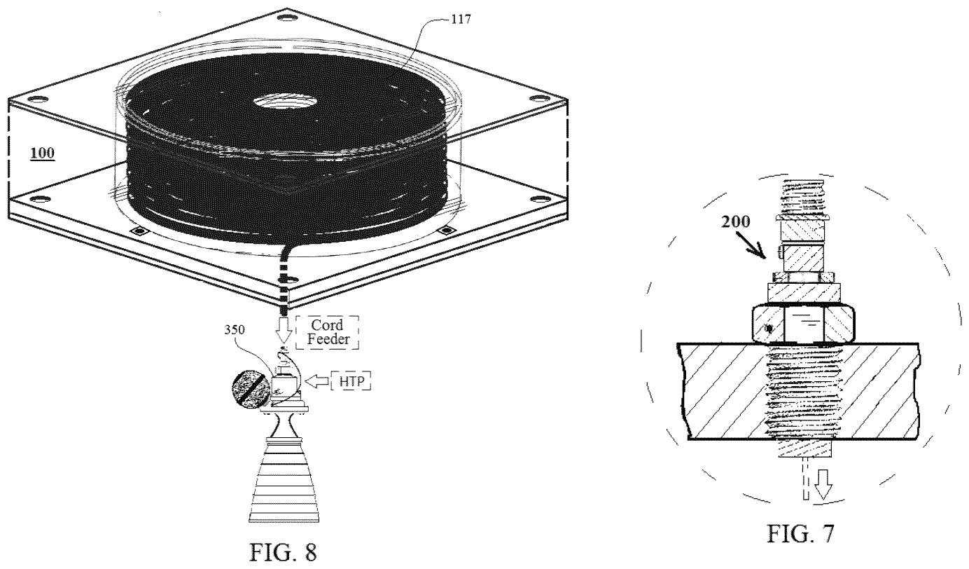

FIG. 7 is an illustration of an exemplary SFT threaded component mounted on a combustion chamber top section for a rapid assembly procedure, in accordance with an embodiment of the present invention. FIG. 7 is an enlarged detail simple schematic of the SFT component 200 attached by its thread section to the upper surface of a chamber wall, an arrow showing the straightforward connecting method.

FIG. 8 is a prospective view of a coiled-type solid propellant cord coaxial packaging 117 for CubeSat propulsion module applicability and a solid-controlled rocket engine, similar to FIG. 6, external mounting position and illustrated axial cord feeding direction, in accordance with an embodiment of the present invention. In reference to the CSRE embodiment 350, FIG. 8 illustrates a straightforward applicability for a propulsion module useful for small satellites (for example, CubeSats) having a squared structure housing 100, incorporating a solid propellant spool 117. The thruster and feeding may be accordingly centrally-axially positioned.

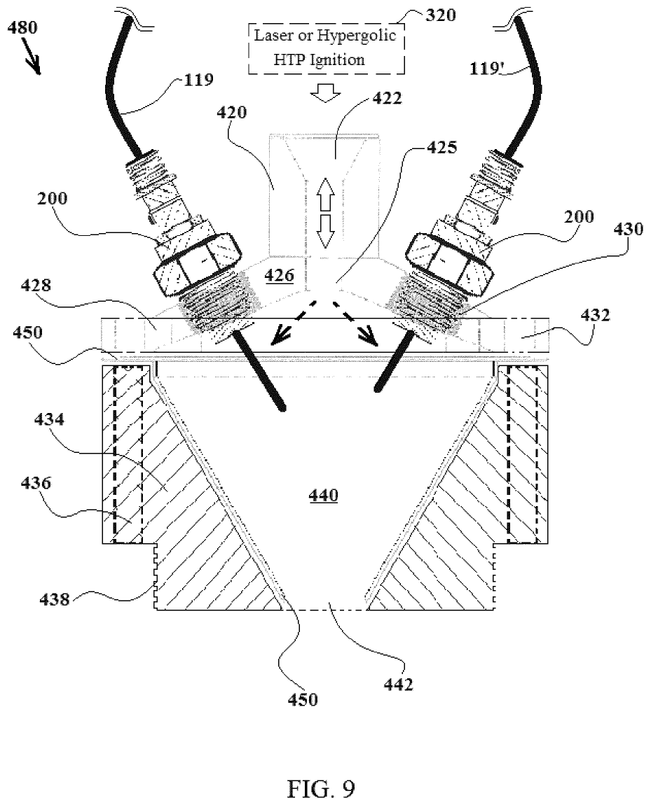

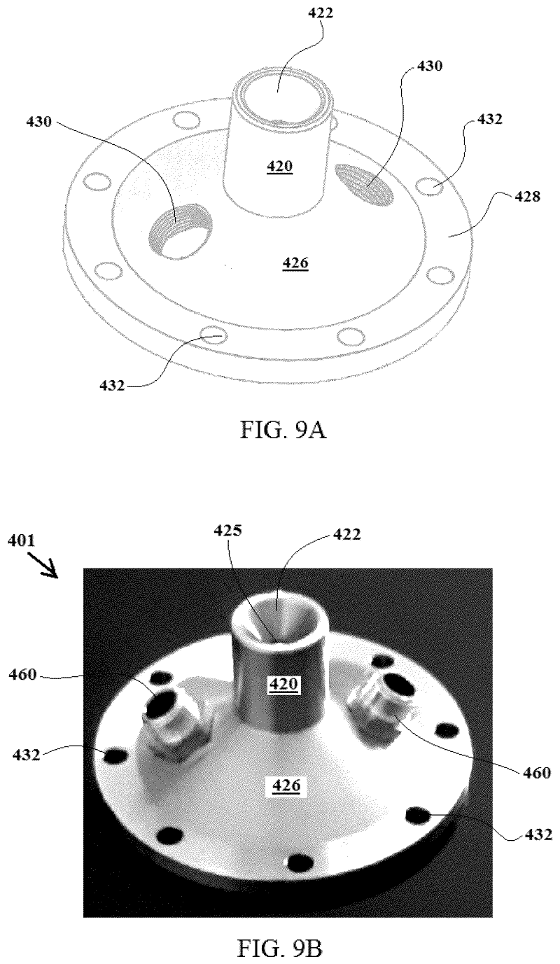

FIG. 9 illustrates a cross-sectional view of a dual use “Common Component” controlled coil-based solid propellant rocket engine conical-shaped combustion chamber, including a set of side mounted SFT's, in accordance with an embodiment of the present invention. A CSRE embodiment 480 (nozzle not shown) is of particular interest because allows for multiple propellant cord entries (example starting from two and above) which gives a base design for either a small or large size (thus higher thrust) rocket engine applications. Also, what makes it very suitable for the present invention, is that its top particular shaped closure is of dual applicability making it ideal for either the CSRE mode or the hybrid propulsion mode. Holds another functionality as well, though not pertinent here. The top and bottom sections of the SCRE embodiment assembly 480 are CNC machined (existing prototype) but may be 3D metal printed as well. A 3D CAD drawing of the top section is shown in FIG. 9A while a photo of the same, the CNC machined prototype, is shown in FIG. 9B. Still referencing to numerals in FIG. 9, FIG. 9A and FIG. 9B, the essential parts comprising SCRE embodiment assembly 480, accordingly in this specific design case of the solid propulsion mode, are an exterior mounted COTS laser 320, to be movable in the vertical plane (up and down). In an alternative embodiment, an HTP spray injector may accordingly be used instead of a laser, without any modification for the top section component 426. The top section is made of a cylindrical section 420, having an entrance conical-shaped truncated cavity 422, with a centrally-axially threaded “tunnel” 425. The body is also formed with a concave or sloped wall 426, in this case forming a 120° angle (the angle may be varied according to different particular designs) with the cylindrical section 420, and a mounting disk-shaped edge 428. Different holes 432 are included in said disk-shaped edge 428 to allow for bolting the two parts together. In our first prototype, for example, the design opted for at least eight holes of 8 mm in diameter. In case metal 3D printing is used for its manufacturing, bolting is not required. Accordingly, the first 3D printed version (in development) requires only one single printing and without the two parts to be joint together. This allows for weight reduction and remains the preferred manufacturing method, though CNC machined parts are still a valid and affordable method of fabrication.

Accordingly, top section 426 is bolted onto the conical-shaped combustion chamber section, having a volumetric combustion space 440. Holes 436 which are part of the chamber “cup” shaped exterior structure 434. Holes 436 are accordingly in line with hole 432 of the top section. The thick chamber wall 434 extends to the bottom with a threaded section 438, which allows for an engine nozzle (not shown) to be directly attachable. The rocket engine throat is indicated by numeral 442. Here, a family of different CSRE performances may depend on specific designs, as well known in the art. Ideally, a similar shaped cup 450, which could also be 3D printed for its fabrication (Inconel alloy for example) or made of a Carbon-Carbon based insulating material, or an oxidation resistant coated niobium heat-resistant alloy, or also a silicon nitride ceramic material. It is positioned and thus assembled in between the two joints, accordingly on top of the “cup” combustion chamber section for extra heat protection. CFD analysis allows for specific parts thicknesses choice and best performance prediction. On top sloped section 426 a number (two shown in FIG. 9) of threaded holes 430 (for reference see also FIG. 9A) need to match the desired number of SFT's 200. The design may feature either same solid cords 119 (with a first diameter) or an optional different diameter 119′. It is clear from the above description that a CSRE may work with different insertion lengths (and related insertion velocities), as shown in the example illustration in FIG. 9. Laser 320 (or HTP injector) may have a retractable coupled safety closure (not shown) in the available top conical space 422, when said Laser/HTP injector is slightly extracted. The same may be into an open position when the Laser/HTP injector is inserted, to prevent the combustion flame to backup and damage the same. If same rocket engine is used in the Hybrid mode (see also FIG. 9A and FIG. 9B), the “Feedthrough-Tunnel” 425 is used to allow feeding from a plastic (or Rubber) filament, by using a COTS Drive Motor & Wheels (FIG. 6A), mounted on the same top section, component 401, assembled by using same holes 432 through a simple dedicated frame (not shown). The side COTS adaptors/connectors 460, shown in FIG. 9B, are meant to be used to attach oxidizer (HTP feeders with coupled catalysts) required to react with the thin plastic filament (s). Furthermore, nothing stops to use the same embodiment design in reverse, that is a propellant cord coming from the center through tunnel 425 and spraying it sideways, through attachments 460. In summary, there are many options available to be used, based on what is the performance and particular use for a CSRE. Innovative embodiment assembly design 480, accordingly, allows for freedom of multi-mode uses, hybrid propulsion included.

FIG. 9A illustrates an exemplary 3D CAD drawing of top section 426, in accordance with an embodiment of the present invention. Top section 426 is a 3D CAD black & white illustration of a particular geometrically shaped “Common Component” feedthrough and ignition support top mounting structure useful for a coil-based solid propellant engine or also a plastic filament-based rocket engine, based on the “multi-mode component use principle”.

FIG. 9B is a CNC machined Common Component prototype in stainless steel based on the 3D work illustration shown in FIG. 9A, in accordance with an embodiment of the present invention.

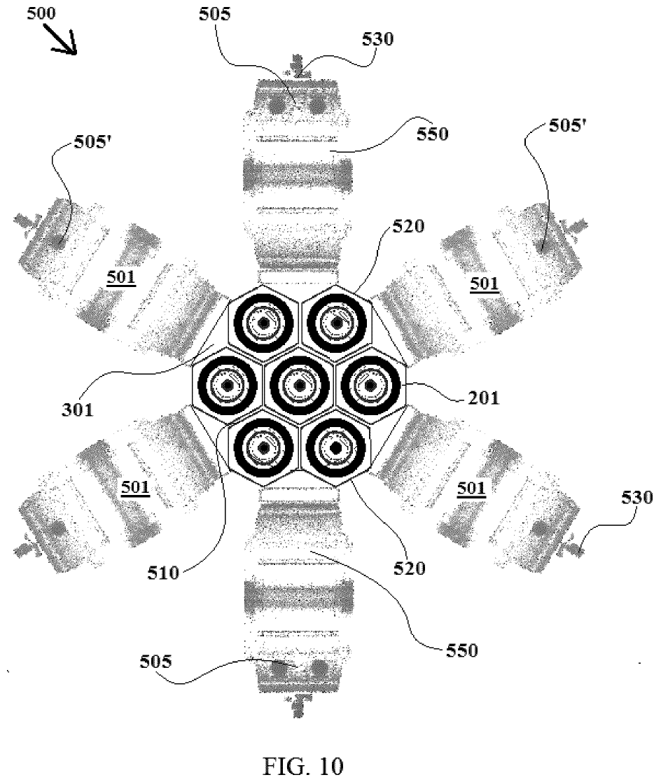

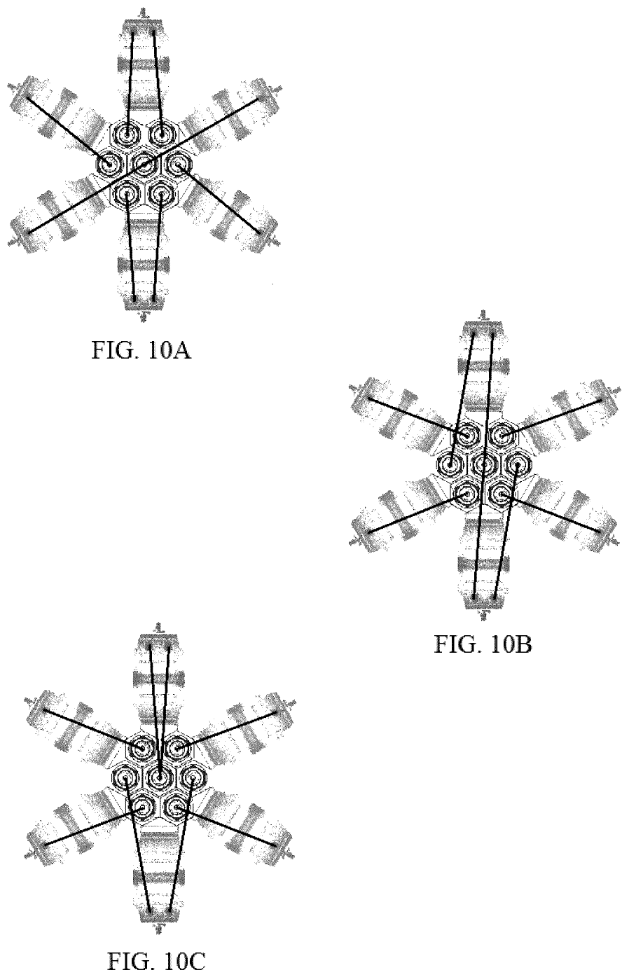

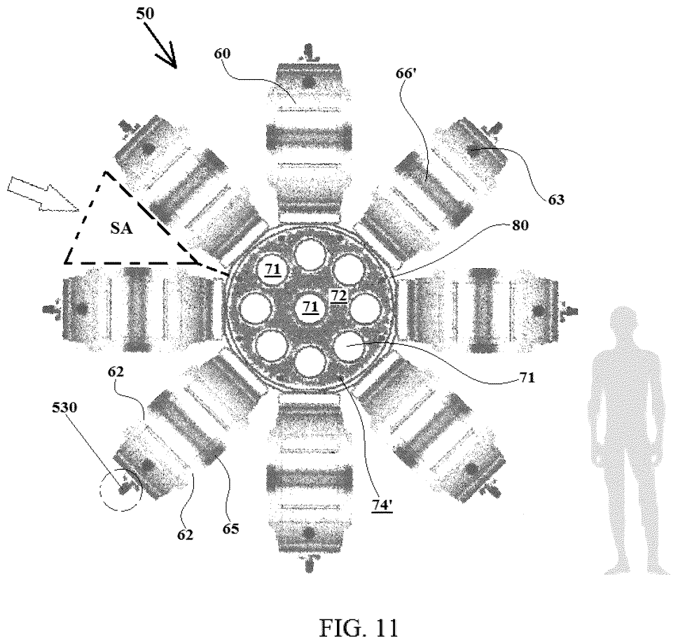

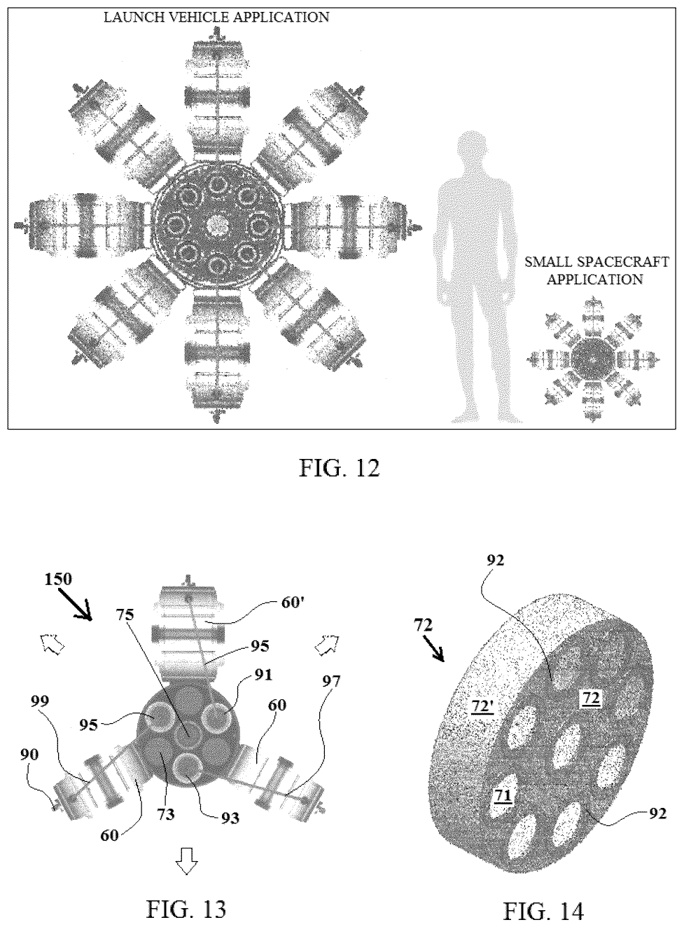

FIG. 10 is a representative top view of a clustered assembly example, in accordance with an embodiment of the present invention. Clustered assembly 500 comprising, not a limitation, six coiled/canister-type housings, based on said canisters forming a “star-shaped” architecture, attached to a center frame formed by seven individual hexagon-shaped assembled modular rocket engine mounting frames, useful as a Space Tug or launch vehicle upper-stage applications. FIG. 10 shows one of the several possible architectures for a horizontal clustered assembly 500 based on small or large clustered canisters attached to a central hexagonal-shaped modular frame 520. This type of architecture is suitable for new Space Tugs or upper-stages. An alternative architectures for a horizontal clustered assembly embodiment 600 is shown in FIG. 11 and FIG. 12, where a human size figure helps better understand, by comparison, one of many possible dimensions which may be realized, for different type of applications. More in detail and referencing still to FIG. 10, the particular clustered assembly embodiment 500, seen from the top, of which a structure frame for payload and/or other equipment is not shown and accordingly not related with the understanding of the present invention. It consists of six canisters (solid propellant housings) each one which may contain solid cords in the form of bobbins. They may be the same or have instead one or more internally mounted bobbins, and they must be mounted symmetrically (one in front of the other) in the same horizontal plane to allow for a centered-axis located center of gravity (cg). Four canister-housings 501, each one having an exit hole 505′ for the propellant cord, assumes accordingly one internally mounted propellant bobbin and two canisters 550, with two exit holes 505 for the propellant cords; that is two propellant cords are mounted internally. Accordingly, all canisters/bobbins assemblies are also mounted to a centrally positioned engine and equipment mounting frame 301 which may comprised, not a limitation in this particular architecture, with a specific number of said central hexagonal-shaped modular-interchangeable frames 520 (seven shown in the figure). Therefore, said central frame 301 may mount at least one CSRE or several ones instead, depending on the required space mission. The rocket engine(s) are not shown in figure and the view seeing from the top. Furthermore, nothing prevents a “mixed design”, that is a CSRE and hybrid propulsion combination. The central frame may have freedom of design choice, hence only to be specific on a case-to-case basis. The central frame 301 may be, for example, not a limitation, cylindrical in shape, shown in more detail as embodiment 72, in FIG. 14 or, as shown in FIG. 10, may be built with said hexagonal-shape (modular structure) 520. Characteristically this allows for a better attachment point for the exterior solar arrays versus a cylindrical-shaped structure. A comparison may be seen by observing architecture 50 shown in FIG. 11, though this last one (the cylindrical shape) allows for more canisters-housings. Single shaded areas 201 (FIG. 10) may be used for engines mounting and/or necessary equipment mounting. The solid propellant cords are not shown in this figure.

The hexagonal-shaped modular engine mounting structure 520 of FIG. 10 allows for a faster assembling, for example through a male/female “slide-in” channel-type assembly, designated by numeral 510. The space in between the canisters 500, hence mounting hexagonal-shaped structures 520, is left for the attachment points and/or bolting purposes for the Solar Arrays. Holes and attachment details are not shown in the figure because it is not relevant for the understanding of the present invention. What matters is that, also, instead of a canister a large solar array, when necessary for high levels of spacecraft power requirements, may be attached onto the same point, that is directly in line with channel 510. The essential scope of FIG. 10 (and the rest of related figures) is to illustrate the various architectures principle, which is an outcome from the invention cord/filament new working principal. Furthermore, canisters may be larger versus the scale shown in the figure. The central engine mounting frame 301 (generally any type actually) may be accordingly smaller compared to the size of a canister-housing. What matters is to evidence the general essential engineering design concept behind, from many other possible embodiments, without departing from the scope and understanding of the invention.

The figures also show that each canister-housing (501, 550, etc.) ideally may also include, not a limitation, an exterior mounting system 530 (with an attached small pod, not shown) for the Space Tug attitude control, mainly, sufficiently small in size and ideally mounted perpendicular to the plane of the canister-housings. Staging Possibilities are essentially shown (the essential of some possible architectures) for illustrative purposes only in FIG. 10A, FIG. 10B and FIG. 10C. It is intuitive that the canisters-housings, which are directly attached to the engine mounting hexagonal-shaped modules, through an outside flexible properly insulated tube (not shown), may be accordingly quick-disconnected (been modular in design) and staged in Space two canisters at the time. A standard COTS explosive bolt or a pneumatic (non-explosive) separation system may be used for the purpose, as its well known in the art.

FIG. 10A is a representative top view of a clustered assembly 500, comprising, not a limitation, six coiled/canister-type housings, based on said canisters forming a “star-shaped” 3-Stage Architecture Space Tug, or useful for a launch vehicle upper-stage application, featuring variable thrust, random stop and different solid propellant cord diameters, in accordance with an embodiment of the present invention. Because each canister may have one or more exit holes for the cords/filaments, and the central structure may have one or more engines, which may or not match the number of canisters, the connections between them by insulated feeding-hoses or “tunnels” (simply illustrated with the dark lines in FIGS. 10A, 10B, 10C), allowing for the “flowing/passing” of the cords/filaments, giving freedom of architectural/packaging design features (canister(s) staging, variable propulsion performance, cargo capacity, engine(s) thrust duration, single or dual mode engine uses, and type of geometrically shaped “strings”/filaments, etc.). One may expect that virtually any given number of hardware elements (canisters, engines and entries) and number and type-shaped propellant(s) may be used in alternate configurations. For example, without limitation there may be differences in the staging option or in thrust management design. Additionally, cord and filament formats can all be mixed for various purposes. The combinations are a multitude (combinatorics) and so are the applications. For instance, FIG. 10B and FIG. 10C show two non-limiting examples of alternate configurations for clustered assemblies.

FIG. 10B is a representative top view of clustered assembly example of FIG. 10A comprising, not a limitation, six coiled/canister-type housings, based on said canisters forming a “star-shaped” 2-Stage or optionable 4-Stage Architecture Space Tug, or launch vehicle upper-stage application, in accordance with an embodiment of the present invention.

FIG. 10C is a representative top view of a clustered assembly example of FIG. 10A comprising six coiled/canister-type housings, based on said canisters forming still another “star-shaped” 3-Stage Architecture Space Tug, or launch vehicle upper-stage application, in accordance with an embodiment of the present invention.

FIG. 11 illustrates the cylindrical shaped central structure architecture, and with a human size figure for comparison, in accordance with an embodiment of the present invention. FIG. 11 illustrates more details of FIG. 10, including the position for the 3-axis spacecraft Thrust Vector Control (TVC) units, in the form of exterior pods, and the solar arrays (doted lines and not fully visible). A large diameter, for example, not a limitation, >4 m, once fully assembled (for example ideal for any large size launch vehicle) is shown as an eight-canister embodiment 50. The holes 71 in the central frame 72 may accommodate either CSRE's or Hybrid propulsion ones, thanks to the design feature of the common hardware component 401 (FIG. 9B), as previously discussed. The Space Tug or Upper-Stage architecture is useful as a dual mode hardware (advanced solid or hybrid propulsion system). Canisters 60 are very much similar to the ones shown in FIG. 10, except that the Inside spool/bobbin may consist of a plastic filament (or rubber-type material) as the fuel propellant. For canisters/housings 60 the construction materials may be Space grade aluminum (7075, properly insulated in and out), Strong-ABS, ULTEM® PEI, PEEK, Carbon PEEK, Neoflon® PCTFE, among the best suitable materials (as low-outgassing materials). Insulation (a “Thermal Blanket”) may always be included, as a final assembled system and ready for Space flight. It is not shown in the figures but may be clear from the context. Canisters 60 may also adopt an attached TVC system, mainly in the form of a small cylindrica Pod perpendicular to said canister-housing (currently under development. Again, the attachment plate, which may be directly mounted on said canister, for example by standard bolts, features a related thread for Pod attachment 530, as before, and hence as a whole hardware component. Details are not shown, since not necessary for understanding of the invention and which may be discussed specifically in a separate patent application, since may include other different novelty.

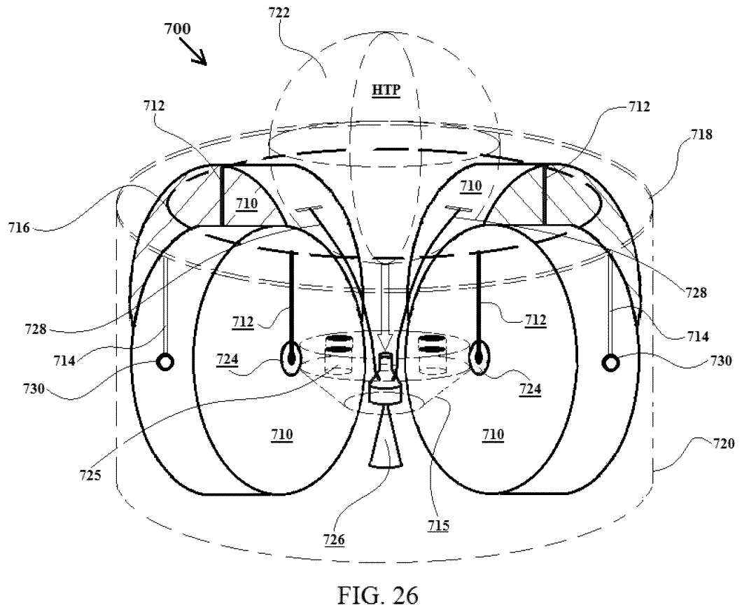

In other embodiments, for large diameters, the central engine frame 72 may also consist of a reinforced exterior cover structure 80 (around the circumference and surface-to-surface contact) and attachable by bolts 74′ which accordingly are evenly spaced apart the circumference of said central engine frame 72. This is done depending on the size and mass of said canisters. Even more, solely the results of specific structure and cost analysis may give the best option to undertake. 3D metal printing, or also solutions offered by new available 3D composite printing (there are actually many other options and materials choice available) may be the best cost-effective methods available for its fabrication. The extra space available 62, that is the symmetrically opposite cylindrical exterior-edge frames which form the whole canister and function as the central canister side lids, may also contain specific equipment useful for the exterior TVC Pod, its propellant, and which may be also in the form of a spool/bobbin (accordingly two for each canister 60) based on the Cord/Filament feeding principle of the present invention. A COTS available monopropellant thruster system may be also used (depending on system size 5N, 10N, 22N, etc.), though this may add complexity and definitely much higher costs. The space in between two canisters, marked in FIG. 11 by the doted triangle and an arrow, is left for the installment of a Solar Array (SA) directly onto the outer reinforcement face structure 80. Attachment details are not shown; it is common knowledge for those skilled in the related art. Furthermore, each canister (also valid in the case for the Hybrid Propulsion method) may use an exit hole 63 for the plastic filament. A centrally positioned rolling cylinder 66′, is used to install the spool on it and which, accordingly, is allowed to move freely. A closing threaded cap 65, one on each side, completes the whole mounting. More details are in FIG. 26.

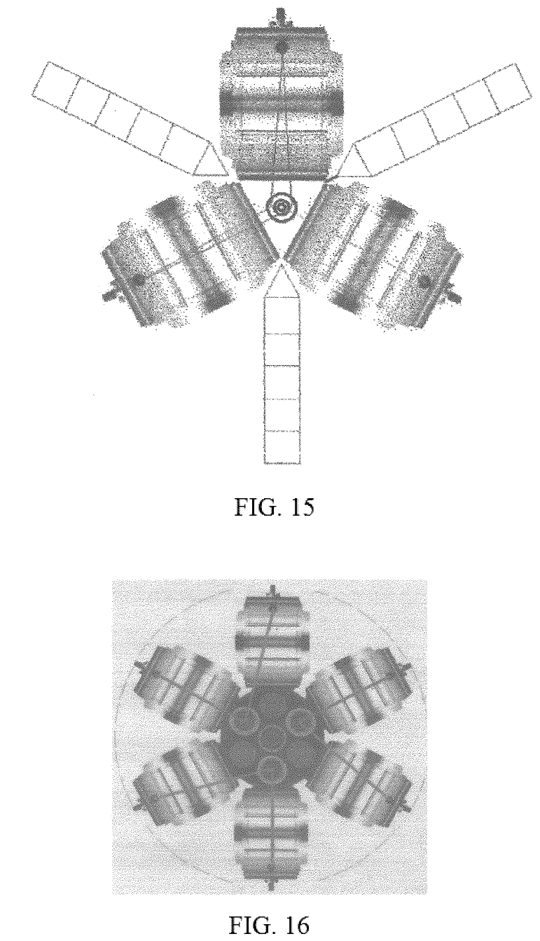

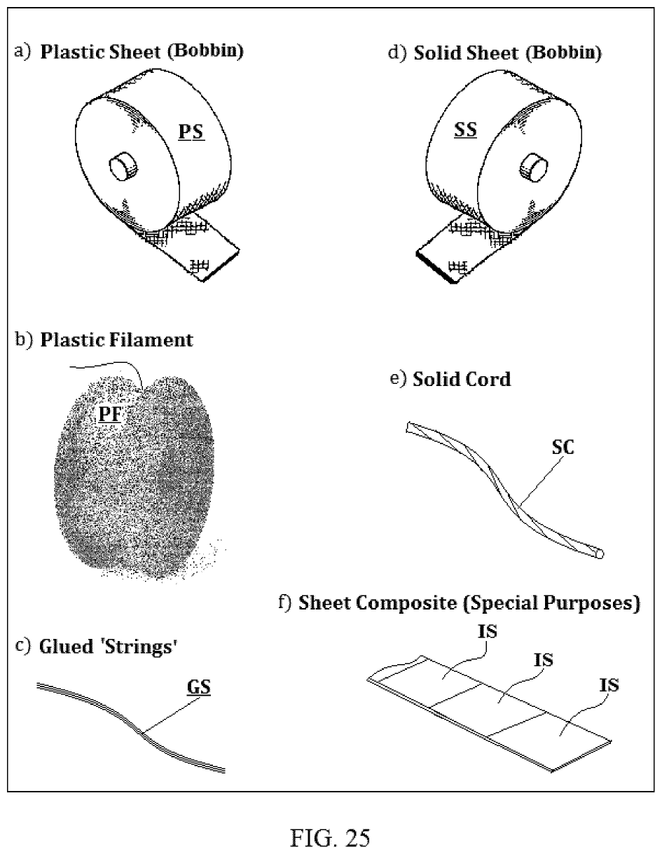

In some embodiments, an architecture which is common to both systems (Solid and Hybrid) is ideal for many possible mission designs and trade-off studies, for all sort applications, and by using small or larger scale propulsion system units. The ones shown, for example, in FIG. 10 and its variations, then FIG. 11, FIG. 13, FIG. 15, FIG. 16 are ideal for large size launch vehicle application or as small Space Tugs, as shown in the comparison similarity of FIG. 12, and previously mentioned. FIG. 12 furtherly shows clearly that the propulsion system, with first mode horizontal assembly, may be properly scaled to fit all space exploration uses. The cords in FIG. 12, which run from the canisters exit holes to the top-center of each rocket engine, and already indicated in FIG. 10 and FIG. 11, may represent accordingly a general application/architecture, hence for use with solid propellant cords or with plastic/rubber-type filaments/cords. Said cords may be ideally of standard cylindrical cross-section but other shapes may be implemented, including as a tape form and/or other ideal form and particular composition. Some examples shown in FIG. 25. Furthermore, usually a flexible (but tensed to a certain degree) Teflon tube (externally insulated) may be used to connect the canister-engine “coupling” for appropriate protection from the Space environment. In the case of a Hybrid system, a toroidal, or spherical, or cylindrical-shaped COTS liquid tank (LOX, HTP oxidizer, etc.) may be mounted on top, to complete a propulsion module (Space Tug, or Upper-Stage) through obviously a separately mounting structure. It is not shown in FIG. 12 but FIG. 26 gives an example side view, of solely four canters for more clarity, to illustrate the architecture more clearly and for a better understanding. Further details are not necessary; may be clear from the context.

FIG. 12 is a schematic size comparison example (same architecture solution) between a human figure and the eight canisters-type architecture of FIG. 10, for launch vehicle large scale application (example, Ariane 6 or Falcon launcher, etc.) and in the form of a small spacecraft propulsion module, either useful for LEO missions, deep-space exploration or missile defense applications, in accordance with an embodiment of the present invention. FIG. 12 further shows that the propulsion system, with first mode horizontal assembly, may be properly scaled to fit all space exploration uses. The cords in FIG. 12, which run from the canisters exit holes to the top-center of each rocket engine, and indicated in FIG. 10 and FIG. 11, may represent accordingly a general application/architecture, hence for use with solid propellant cords or with plastic/rubber-type filaments/cords. Said cords may be ideally of standard cylindrical cross-section but other shapes may be implemented, including as a tape form and/or other ideal form and particular composition. Some examples shown in FIG. 25.

FIG. 13 is a representative top view example of a modular assembly Space Propulsion Tug 150 comprising three coiled/canister-type housings mounted on a center circular frame, formed by seven mounting or attachment “common hole-points”, three of which are directly in line with and connected to said canisters-housings, three mount the CSRE's, thus connected directly with said canisters-housing by feedline hoses, and the centered one which may mount an optionable different type propulsion system or other mission required equipment, in accordance with an embodiment of the present invention. The Space Propulsion Tug illustrates a further possible embodiment 150 comprising three canisters, which may vary in size. Canister 60′ is slightly bigger (same diameter but wider) than the other two, canisters 60, which may be the same size, for example. All three are mounted on a center circular frame 72′ (a more detail of this mounting frame embodiment 70, with seven mounting holes 71, may be seen in FIG. 18), thus formed by seven mounting or attachment “common hole-points” 71. Three are directly in line with and connected to said canisters-housings 60 and 60′. The possible-different applicability here is to use, for example, not a limitation, three different filaments (covered by related insulated feedline hoses 95, 97, and 99), may vary in diameter and/or material composition (HTPD rubber, high density polyurethane, ABS, etc.), and accordingly be designed such that the center of gravity still remains perfectly centered. This, obviously is in regards hybrid propulsion. The same applicability principle is also valid in case of the CSRE. In both cases, for hybrid and solid, the natural choice is to mount a centered thruster 75. For both cases (again, valid for solid or hybrid) ideally three perpendicular distribution systems (details not shown) 91, 93 and 96, which basically may consist of three “continuation coils/spools” (coming from the two 60's and 60′) and related feeders which are in direct connection with the centered thruster 75. This design feature allows for better variable thrust range, hence by feeding said thruster 75 with different solid propellant cord diameters, or different plastic-filaments in the case of a hybrid thruster. Therefore, no matter the version, thruster 75 must have, in this particular case, three cord/filament inlets capable of simultaneous feeding and/or independent feeding capability. Furthermore, canister 60′ may be equipped with a propellant cord with a smaller diameter versus the canisters 60 and vice-versa. Nothing prevents to have a mixed hybrid-solid combination design either. What matters is that the central mounting frame 72′ is useful with at least one engine, or with multiple engines installed. Accordingly mounting holes 71 (FIG. 18) are useful for canisters mounting, at any designated connecting point 73, or equipment, payload, propulsion, propellant tank, etc., to make up a specific spacecraft design. Spacecraft Attitude Control may remain the same, by using attachment point 90, for the related external pods, as previously discussed for the other embodiments. The three arrows, accordingly, show the direction for the direction of extension for three solar arrays (not shown) mounted at 120° angle from each other.

FIG. 14 is a 3D CAD black & white prospective view of center circular frame 72, formed by nine mounting or attachment “common hole-points” 71, based on the spacecraft propulsion module applications of FIG. 12, in accordance with an embodiment of the present invention. Flat O-rings 92 are made visible (the darker flat rings in the figure) on the top-base surface for engine or canister mounting; same discussion as for FIG. 13 is valid here. The top section, which includes an extended cylindrical wall 72′, makes available an internal space for thruster(s) mounting, required subsystems, power, wiring distribution, etc. Elongated versions, versus the more compact version 72, may offer extra available space for extra necessary equipment and/or an eventual other type of monopropellant tank.

FIG. 15 is a representative top view example of a featured modular assembly Space Propulsion Tug comprising three coiled/canister-type housings mounted on a center triangular shaped frame, formed by a single attachment centered “common hole-point” mounting a single CSRE, in line with and connected to said three canisters-housings, with multiple feedline hoses to allow for better (wider range) variable thrust performance, in accordance with an embodiment of the present invention. FIG. 15 is a representative top view example of a featured modular assembly Space Propulsion Tug comprising three canister-housings mounted on a centered triangular shaped frame, formed by a single attachment centered “common hole-point” which mounts a single CSRE, in line with and connected to said three canisters-housings, with multiple feedline hoses to allow for wider thrust range and better variable thrust feature.

FIG. 16 is a representative top view of a clustered assembly example comprising six coiled/canister-type housings for controllable solid propulsion application or as an optional hybrid propulsion architecture (three plastic-filament coils and three HTP tanks) for large Space Tugs or medium/heavy launch vehicle upper-stage applications, in accordance with an embodiment of the present invention.

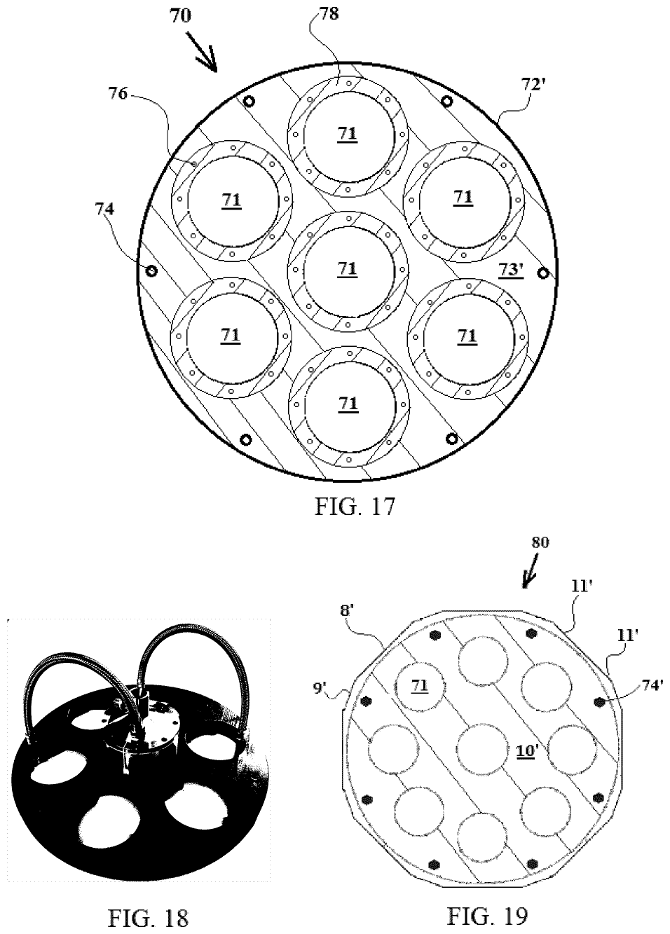

FIG. 17 illustrates a top detailed view of an exemplary seven “common hole-points” center circular mounting frame 70 of FIG. 13 or of FIG. 16, in accordance with an embodiment of the present invention. Circular mounting frame 70 may comprise, not a limitation, seven “common hole-points” 71, mounting holes 74, and disk-shaped grooves 78 which serve to house similar shaped O-rings.

FIG. 18 is a perspective view of an exemplary black & white photo of a 3D printed prototype of seven “common hole-points” center circular mounting frame 70 and a first version prototype of hybrid propulsion engine, in accordance with an embodiment of the present invention. The disk structure is sufficient to accommodate one or more thrusters and canisters (as shown) but larger diameter Space Tugs, as the example shown on the left side of FIG. 12 (>4m in diameter).

FIG. 19 is a top view example of an optional secondary central structure reinforced embodiment 80, ideally comprising at least one, or more, side wall(s) 8′ for large heavy canister(s) connection (see FIG. 11), at least one, or more, side wall(s) 9′, for solar array(s) and/or antenna connection(s) or other spacecraft hardware, a top flat surface 10′, and coupled or connected with said disk-shaped structure 70 of FIG. 17, through common coupling-connection holes and thus bolts 74′. It may also be manufactured as a whole (without connecting disk 70), for example CNC machined in aluminum or 3D printed in composite or special plastic material, though the whole assembly is thought out to be useful as a modular-interchangeable solution useful for small or large diameters. Same as the disk-shaped structure, it may be manufactured with a plurality of main mounting holes 71 (nine shown in figure but not numerically labeled). Those skilled in the art will readily recognize that mounting solar arrays typically depends on the spacecraft power requirements. Connecting-coupling options are such that said disk structure 70 may be mounted against said flat front surface 10′ of the reinforced structure, either in the front or the back, depending on the specific intended layout between propulsion, necessary equipment, and intended planned payload(s), which may be mounted (architecture dependent) as well on the side of said wall 8′ through at least one, or more attachment point(s) 11′ (side holes, not shown) by COTS hardware.

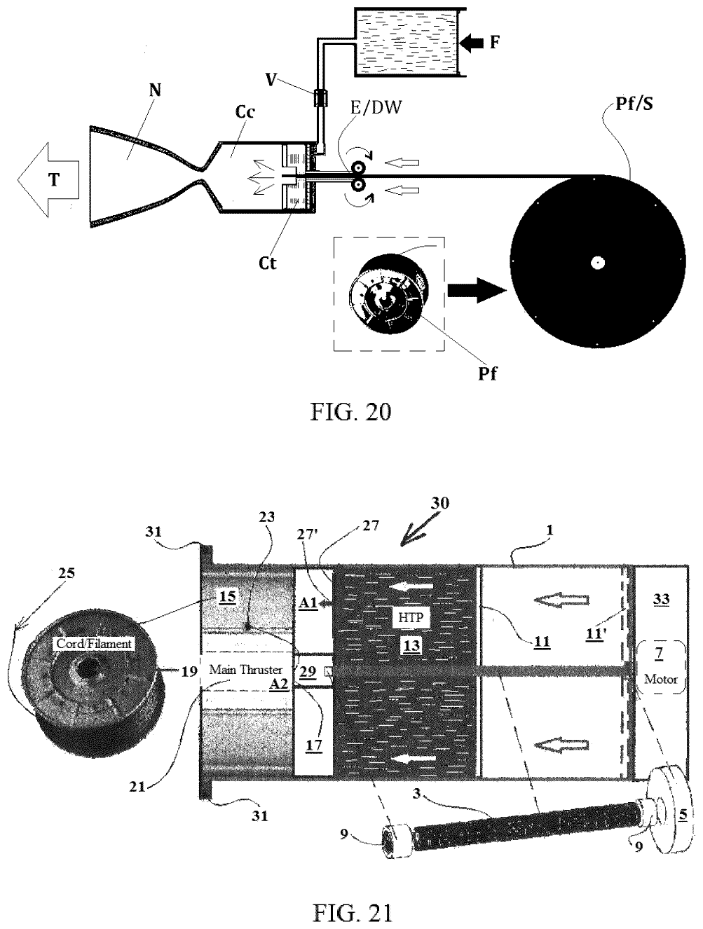

FIG. 20 illustrates a simple schematic of the principal of operation of the invention, valid for plastic-filament, controllable solid propulsion systems and, as clear from the context, the general tri-mode use principle, in accordance with an embodiment of the present invention. The simple schematic of the principal of operation of the invention, valid in the form of a plastic-filament Pf or, as preferred, a solid propellant cord S for CSRE use. Accordingly, it is convenient to use HTP for the hybrid mode and as the hypergolic and reliable ignition source for the CSRE mode. If, for example, small control thrusters (HTP-monopropellant based) are desirable, the monopropellant mode may be, accordingly, incorporated all in one system. In the CSRE mode, as seen from previous discussions, also a laser or WFNA (White Fuming Nitric Acid) may be used as reliable ignition sources for the solid propellant, though the HTP offers its many advantages. The CSRE is started when the propellant cord is ignited in the hypergolic mode by HTP. The cord may be already inserted into the combustion chamber Cc, for a small portion (cm in length of time) and which may be indicated as the “insertion length” (lI). During a normal operation the solid cord may be smoothly and continuously inserted by a COTS control driver system on command (wheel-based) E/DW. This method is also valid for the hybrid mode of operation. The hypergolic ignition, based on lab tests made at the ACSYNAM Company, is pretty reliable and fast, hence allowing for a very simple and reliable anytime restart capability through the CSRE configuration of the present invention. Necessary required amounts of HTP, for example in a pulse mode operation, are very small (only a single liquid drop is sufficient for the solid propellant ignition) and this allows for future compact propulsion modules designs. A “syringe-type” tank T, with the use of a command/controlled force F, may be used to push the liquid HTP into the contact solid-liquid “zone” of the combustion chamber Cc, thus by a piston or diaphragm in forward motion. A control valve V may accordingly be part of this simple working system. The continuous feeding of the ignited solid propellant cord S inside the chamber (similar in principle to a 3D printer when a drive wheel system is used) may keep the combustion of the same ongoing, with the hot gases which then may escape from a nozzle N, generating a thrust T. Accordingly, in the hybrid mode the thrusters may include, as well known in the art of hybrid propulsion, a catalyst bed Ct. Furthermore, present work focuses on the use of HTPB as fuel (hydroxylterminated polybutadiene), because it enjoys a slightly higher regression rate. Polyethylene (PE) represents a unique fuel choice. It is a thermoplastic which is commonly produced, has a lower cost than HTPB, and the thermochemical combustion performance of the two materials is virtually identical. For these reasons, PE material, not a limitation, represents an attractive alternative for many future missions, depending on the preferred choice. The use of HTP/Polyethylene (PE) propellant combination may be traceable to the mid 1950's, with the tests of Moore and Berman which were quite successful at the time, though higher energy propellants, as in the case of new generation solids, are always desirable.

FIG. 21 illustrates a cross-sectional view of a propulsion module straightforward design 30, based on the plastic-filament hybrid propulsion or the controllable solid propulsion method, in accordance with an embodiment of the present invention. The cross-section simple schematic of FIG. 21 illustrates how the working principle of FIG. 20 is actually transformed into a working simple prototype. The hybrid/solid mode shown in the figure accordingly may adopt a COTS plastic-filament 25) in PE (or solid propellant cord), for example contained in the form of a spool 15. A small compact propulsion module useful as a spacecraft subsystem is the simple outcome here, and currently under development by the inventor in its solid propellant cord version. The HTP cylindrical tank 13 is much larger for the hybrid mode, needing a much greater and sufficient amount of oxidizer in order to work properly, than the CSRE mode which only needs a small ignition source. The CSRE mode may use 1/100 for normal use and some 1/10 for a pulse mode use versus the hybrid mode. The forward smoothly controlled movement (shown by the arrows) of the disk-shaped diaphragm 11 (at full tank is in the position 11′, as shown by the broken line) is set in motion by the rotation of a centered positioned jack screw 3, accordingly centrally mounted on the longitudinal axis of the propulsion module embodiment 30. At least four attachment points, indicated with numeral 31 (at 90° angle) from each other, form the forward end of the propulsion module 30 which may be used for connection purposes with a satellite or cubesat type spacecraft.

Still referring to FIG. 21, in some embodiments, a servomotor 7 (with a reducer) is used for rotation of said jack screw 3, connected at its ends with the two couplings 9 and a bearing housing 5. It is allowed free rotation. Batteries, related servomotor control system, and other necessary electronics may be stored/assembled (details not shown) at the aft section 33. The whole containment cylindrical structure 1 may be manufactured in space grade aluminum alloy (7075), though a 3D printed module, for example in PEEK or Ultem® PEI material, is preferred because it allows for good weight savings (density of PEEK is 1.3 g/cm³ versus that of aluminum, 2.7 g/cm³); is strong and chemically compatible with HTP. It is more expensive than aluminum but advantageous. The central section 29 may house the drive wheel system for the filament/cord 25. The thruster 19 is positioned at the module's forward end, thus axially positioned respect the spool assembly 15, which is normally empty in the middle, thus making available the central-axially volume 21. All related system sizes are dictated by specific design requirements. The CSRE type may use in this case only one feeding inlet for the solid propellant cord 25. The same discussion is valid for the hybrid mode, with the scope to keep the whole propulsion module as simple and compact as possible. A COTS Teflon® feeding hose (not shown) may be used, which allows the solid cord or filament 25 to pass through. Accordingly, may run appropriately from the side, with the solid cord or filament exiting said spool at point 23, hence close enough to the entrance point 17, and enters the thruster 19 from its top. The HTP cylindrical tank 13 ends prior to the spool edge, example at point 27, where the tank closing cap is positioned. When it gets pushed by diaphragm 11, said HTP liquid exits at point 27′ (the desired exit pressure is function of the exit area A1) and enters near inlet point 17 (having an inlet area A2) directly to a solenoid valve of the thruster 19 (details not shown in the figure). Basically, in the case of the CSRE mode, the solid grain cord 25 enters firstly the SFT (the Safety Feed-Through). The solid cord commences to burn at the surface of its exposed end. The propellant grain cord 25, depending on the required thrust, may be inserted with a speed equal to or greater than the linear burning rate of the solid propellant, rb, protruding into the free burning space where combustion takes place at all exposed unrestricted surface faces thereof, usually starting at the downstream end of the propellant cord. The amount of solid propellant supplied into the thrust chamber is determined by the flight program, which takes into account the rate at which the said propellant cord burns, rb, which accordingly provides for a programmed computer controlled solid grain insertion/feeding velocity, vI=d(lI)/dt (in cm/s), which is usually constant for constant thrust profiles. The mass burning rate at any time is the product of the linear burning rate multiplied by the total number of cords inserted within the combustion chamber (valid for general cases). If the rate of advance of the solid cord into the chamber is increased beyond the minimum rate of the propellant, which is equal to said linear burning rate of the propellant, the cord(s) (again, generally speaking) are being consumed still at the linear burning rate, for any given solid cord design. If the solid grain is designed with another embodiment (example, into a flat tape-format like form) with a grain thickness greater than its linear burning rate then said grain, example for large CSRE assemblies or as shown in example of FIG. 25, may be advanced faster than being consumed at the linear burning rate. Either way, with small or large CSRE embodiments, the result of this is to be able to vary on command the length of the free burning cord within the combustion chamber, by keeping the combustion always under control in the internal space of the combustion chamber.

Referring to FIGS. 1 and 21, as a solid propellant cord (shown in FIG. 1) burns, one section at the time, the linear dimensions, that is the length of the cord propellant, Lp, and mass of said propellant are decreased in time. The amount of propellant mass flow rate: mp=dm/dt=KL lI(t) [Kg/s] is strictly proportional to a cord constant, KL, which depends strictly on their design, that is chosen propellant (hence its density), cord/string length chosen, particular shape (e.g., cylindrical, tape-based, etc.) and also any given specific dimensions of the same (diameter or thickness and width, etc.). The propellant cord length, Lp, becomes smaller with consequently having an “insertion length”, n, rate in time lI(t) (cm/s) that is only controlled in a manner which may be either pre-programmed and/or a function of command signals received by the spacecraft during flight or as a function of combustion chamber pressure. In essence, it is function of the required flight profile and necessary required thrust at a giving moment. For each individual flight program, lI(t) varies to a programmed insertion velocity, vI=d(lI)/dt. Because the cord/tape (sting technique) gives us the advantage to design small or large CSRE's, any insertion velocity may be designed for low or high-rate insertion application, though always in the order of cm/s, and for variable thrust profiles in the range of a fraction of a N (Newton) or hundreds/thousands of times larger.

As previously pointed out, each specific CSRE design has its own cord constant KL, that is a specific (designed and manufactured) “propellant mass per unit length” (or “cord constant”), KL=Mp/Lp, measured in [Kg/m], and given by the ratio of the total propellant grain mass, Mp, and its length, Lp. Here, KL may be a useful factor which may be utilized for programming purposes for an eventual, to be used equipment (e.g., a measuring laser) in large spacecrafts, for the determination of the instantaneous CSRE thrust and history, instead of considering burn surface areas that vary in time, A(t), as usually done in standard motors and which are not always reliable in this sense because of potential grain cracks, pressure oscillations, etc. So intrinsically the controlled cord/strip method gives a more precise propellant mass rate a priori. Thus, the more practical insertion function lI(t) (again, the insertion depth that varies in time) may be useful for practical-measuring applications, for a mass properties study, etc. Future Space Tugs manufacturing may be customized for certain Space missions, hence be a direct product-answer of specific requested mission objectives, and have pre-manufactured ΔV (delta V) to use and basically choose from.

A recording for lI(t) may be determined by either a direct feedback system (not shown) such as a laser device, for length measuring of said cord during insertion or basically an unrolling bobbin, thus equally measuring the decrease of Lp, or −ΔLp, because −ΔLp=lI,0+lI(t), that is the propellant-coil length decrease in a spool equals its increase (in time) that passes through the SFT, intrinsically measuring the rate of solid fuel consumption and record the data with the use of an onboard computer. The amount no is simply “the starter” length, that is the initial amount that may be kept inserted into the combustion chamber prior to engine start, for obvious reasons of easy combustion start-ability. Finally, the insertion length, n=Lp/nb, may be considered constant for constant thrust profiles. Here, nb is equal to nb=tb/Δtb, is nothing more than the ratio between “the burning time” (in seconds) and the “unit time”, that is Δtb=1 s (one second) basically a unit-less “burning number”. Accordingly, this is simply done, that is to define lI=Lp/nb and therefore relate the propellant cord/strip length with the propellant burning time because, obviously at this point in the discussion, it is useful for this new spacecraft propulsion design to imagine the propellant cord divided, along its longitudinal axis, in a number of segments equal to the given natural burning time. It is useful for programming purposes. Theoretically, for better precision purposes, during grain length definition and related measuring design hardware, the value of nb=tb/Δtb, may be taken smaller if we define the unit time in fractions of a second (example, milliseconds or 10⁻³ s) instead of one per second. Any person skilled in the art, and especially any designer of related measuring instruments or hardware, may select the use of the previous unit-less time related definitions for practical measurement purposes. It is also intended that such data collection is especially useful during new motor testing and certainly useful during a Space mission data collection.

Propulsion module 30 (or any CSRE system in general) may use several pressure and temperature transducers (not shown) respectively located in convenient locations of said CSRE for data recording. Readings may be transmitted to a computer (not shown) to allow pressure modulators, for the combustion chamber and for the safety and shutdown gas quenching system, to control the gas quenching pressure valves (not shown) to work properly and maintain the distributed gas quenching pressure above the chamber pressure, during a rapid shutdown sequence. For the purpose of terminating the thrust at any desired time, it has heretofore been provided the means to do so in such a system accomplished by the SFT 200 assembly and sub-assembly 264 (FIG. 4 and FIG. 5) by “pumping” said suitable gas quencher (normally CO2 or even a solution of water and soap for large size CSRE systems) from tank 330 (FIG. 6) for quenching the burning, preventing the produced hot gases from passing by the SFT 200 assembly in which a “safe pressure” (or “flame back-up pressure”) is maintained slightly higher than the combustion chamber pressure of which, as a result of the pressure differential, gas or some water solution is allowed to pass into the combustion chamber 380 and vaporized, hence passing-through initially the whole SFT 200, including the end (top chamber basically) safety boundary layer 266 (FIG. 5), linear side grooves 268 and jet-cutters 268′, onto the grain cord at a rate sufficient to prevent the combustion at the grain surface from progressing within said SFT assembly in an upward direction, thus forming a continuous film on the grain and complete blockage as a primary extinguishment procedure.

When it is desired to stop the operation of the CSRE, the drive wheel feeding system 360 rotation (FIG. 6, FIG. 6A) may be stopped, accordingly stopping the further entrance of the propellant cord. Contemporarily a “quenching gas/fluid valve” could be increased in its opening allowing for the quenching gas to extinguish immediately the burn flame at the outlet, basically at the location of the exterior safe cap 246 (FIG. 4 and FIG. 5), considered as the primary “safe line” of the SFT (initial of a series as clear from the whole discussion), totally “flooding” (covering and cutting the cross section surface area) of the propellant cord by said transverse thin cross-section jet of high pressure quenching gas/fluid from said jet-cutters 268′ openings. Striking is done in a normal direction to the surface of the propellant cord, consequently physically cutting off any small eventual grain residual left over from the jet cutting line, in its function as a “flame plug” (or combustion flame seal), blowing it back into the combustion chamber and/or out through the nozzle thereby cutting off the burning portion of said propellant cord and stopping combustion in a very fast and reliable way. Therefore, any eventual residual small burning area is insufficient to produce the necessary pressure in chamber (or even inside a SFT) to support any possible combustion which might tend to continue, which may be immediately after extinguished by the backup (or secondary sets) of generated transverse quenching gas blasts. CSRE's and SFT subsystems are intended to be very safe thrust systems.

To restart the CSRE, for a second burn or a pulse mode, the propellant cord may be inserted into the combustion chamber in a “In & Stop” feeding mode, and re-igniting rapidly by HTP contact. Continuous self-sustained combustion is due to the continuous grain insertion. But given the solid propellant rapid ignition (again, only milliseconds of time delay) and with the availability of excellent COTS rapid pulse-mode fluid valves, rapid pulse operation is feasible. For long duration or high thrust operations, a minimum safety pressure in the SFT subsystem may be opportunely kept on and controlled by computer command, again with a pressure slightly above chamber pressure for normal engine operation and avoid any possible whole safety system overheat. The combination of applied research on these new propulsion technologies may allow the use of the right technology at the right place to offer the required performance at the lowest price possible. Ultimately, the choice of the CSRE propulsion system for all the stages of a planned deep mission spacecraft may be a trade-off between performance, launch objectives and cost.

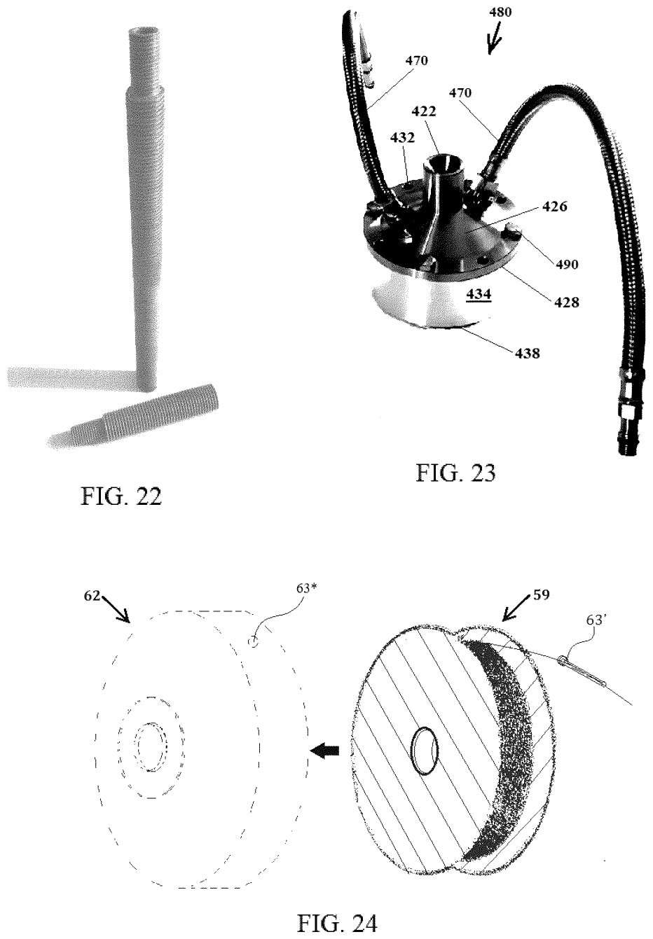

FIG. 22 shows a 3D printed prototype in PEEK material of a jack screw for the propulsion module High Test Peroxide (HTP) tank of FIG. 21 (currently under development in its CSRE mode for small satellite applications), in accordance with an embodiment of the present invention.

FIG. 23 is a black & white photo of a first prototype of a multi-mode use new generation rocket engine 480 (nozzle not shown) with the actual hardware based on the cross-section schematic shown in FIG. 9, in accordance with an embodiment of the present invention. The two feeding-hoses 470 (not for flight use but only for ground demonstration purposes) do not bring liquid to the combustion chamber, as normally done in classical rocket engines. They are used for connecting with the canister-housings and accordingly carry the passage of solid-cord hypergolic propellant or a specifically sized plastic-filament for the hybrid mode. Ignition HTP (in small amounts) is allowed to pass through the central-axial multi-purpose use tunnel 422. Rocket engine 480 is shown with the two half sections, chamber section 434, and top section 426 comprising said tunnel 422. Top section 426 further comprises mounting holes 432 that may enable top section 426 to be connected by bolts 490 to chamber section 434. In addition, rocket engine 480 may further comprise O-ring 428 and a threaded section 438 for nozzle attachments and other mounting purposes in various different embodiments.

FIG. 24 illustrates a simple schematic prospective view of the essential elements necessary to form a solid-cord propellant canister-housing and related interior coil (or bobbin). Reference is now made to FIG. 24 which illustrates a simple schematic prospective view of the essential elements necessary to form a solid-cord propellant canister-housing 62 and related interior spool 59 and it is common to both, new hybrid and CSRE applications. A canister body embodiment 62 may be usually cylindrical in shape, made in Space grade aluminum, or 3D printed in composite material (COTS available) or also made in 3D printed Strong-ABS or Ultem® PEI material, all options of which may be followed by proper insulation of said canisters for the use in the Space environment. To allow for the cord/filament to exit a hole, the outfeed device port 63* is used for the purpose, where a cord/filament guide 63′ becomes useful by connecting it with said outfeed port and helping the outfeed. Connection with an exterior feeding hose (example made in Teflon®) is done by standard means well known in the art (threaded connection, etc.). Canister body 62 may adopt a lid (not shown) which may use simple screws to be attached on and been flat or slightly rounded in shape, to form accordingly a whole symmetric body. The lid is necessary to properly seal the interior mounted spool (bobbin) 59 (shown prior to mounting in the figure) and allow to keep said spool in an appropriate insulated canister, also with the help of said insulation that must surround it, for example with a thermal blanket.

Solid propellant cords or bobbins may be manufactured in several sizes and one or more shapes (cylindrical to be a classic). FIG. 25 illustrates six simple views, in accordance with an embodiment of the present invention, of the most obvious formats which, for hybrid propulsion also includes a standard COTS well known Plastic-Filament PF or also a Plastic-Sheet PS. The Solid Cord instead may be a single cord SC, made into a solid sheet-rolled (bobbin form) SS, by gluing together multiple small cords (Glued Strings GS) or as a special purpose composite sheet or tape form, made of individually connected sections IS. Flat built bobbin-type, or also in COTS Reelex® format packaging, solid propellant may serve very well for use as high thrust advanced CSRE applications, and it may include first stage propulsion uses and/or reusable Single-Stage To Orbit (SSTO) future applications. Furthermore, the manufacturing methods may be similar to COTS PETN solid explosive detonation cords or pyrotechnic Visco cords, already well known in the art and used in the mining and construction-demolition industries. Materials for its exterior envelope/protective coating may be the same or thin film plastics, such as high density polyethylene, Teflon®, wax-based or cellulose-based type paper, may also be used. Other uses, once sufficient experience is built along the way, may be made with even more sophisticated bobbins and/or cord types of different lengths. Cord feedings may be made in, not a limitation, continuous form or in cords such that the feeding is intermittent (as previously mention as form IS in FIG. 25), in bits (example for a micro-pulse type use) in the form of small separated pellets (flat, ball or other shape/forms). Because the new propellant is hypergolic, it is definitely of big advantage. Electric ignition may also be adopted, as previously discussed. This allows to design future systems with incredible type of applications and thus freedom of choice for different type of spacecraft and the like.

FIG. 26 is an illustrative example in the form of a simplistic perspective view of a Space Tug embodiment, with four canister-housings and a single axial thruster, the modular-interchangeable design of which may be used for SCRE or hybrid propulsion applications, in accordance with an embodiment of the present invention. The simplified perspective view schematic of FIG. 26 shows an example of a four-canister assembly 700 with said canisters 710 mounted at 90° angle from each other. The schematic shows that, besides the previously assemblies shown from a top view, the modular approach offers assembling options and design freedom. The CSRE and the hybrid propulsion application may differ only by the addition of a large HTP tank 722 (shown as spherical in shape in the figure with broken lines), which may be COTS available in certain sizes. Feeding to central-axially positioned thruster 726 may be axially as well (shown by the downward central arrow). While CSRE only requires small amounts of HTP, besides the previously mentioned other ignition options, hybrid propulsion as well known in the art, requires specific oxidizer/fuel ratios in order to work efficiently. A large HTP tank 722 may be absent for a CSRE application. In terms of structure weight efficiency, the modular canister approach allows for a lighter structure and staging possibilities, depending obviously on mission requirements. Mounting methods for canisters 710 may vary, though standard launch vehicle bolting techniques may be used (explosive bolts or a pneumatic separation system in case staging is applied), starting with central thruster mounting structure 715, which holds central-axially positioned thruster 726. Because four independent solid propellant cords 728 are fed to said thruster (for CSRE application), at least one or four separately mounted small HTP tanks 725 may be directly mounted on central mounting structure 715.

The canisters and the central structure may also include a payload/instrument disk-shaped floor panel 718, which is attached to a supporting/reinforcement ring-shaped structure 716 of which also the four canisters may be attached to by eight side vertical struts 712 (two for each canister) by the use of ring adaptors 724. Space Tug 700 may furtherly use external connecting struts 714 which may be mounted in between said floor panel and a set of four exterior mounting adaptor rings 730, bolted to a reinforced exterior-edge section of each canister (details not shown). Exterior rings 730 may be also used for assembling purposes with an eventual exterior cylindrical protective structure 720. For a deep-Space mission, said structure may be staged allowing for an overall better structure efficiency and, accordingly, freedom to stage said canisters (discussion also valid for the Reelex® format packaging). When one examines carefully the whole prior art, with the understanding that certainly further progress has been made along the years, yet that does not represent a final “progress/technology conclusion” and, accordingly, there is certainly still room not just for improvements but also a total new method of solid-controlled propulsion use, higher performance versus the prior art and vast applicability capable to satisfy future industry requirements through this new pioneering field.

The teachings in this disclosure have applicability to solid and hybrid rockets and permit one of skill in the art to explore the technological limit of what is possible. It is to be understood that variations in the manner of operation and construction of the various embodiments of the invention, all systems and/or methods disclosed and claimed herein may be made and executed without undue experimentation in light of the present invention. While the systems, the construction, and methods of this invention have been described in terms of embodiments, it may be apparent to those of skill in the art that variations may be applied to the systems and/or methods of construction, and in the steps or in the sequence of steps of assembling the system described herein without departing from the concept, spirit and scope of the invention. More specifically, it may be apparent that certain components of the disclosed systems, and/or modifications may be substituted for the ones described herein to achieve similar results. All such substitutions and modifications apparent to those skilled in the art are deemed to be within the spirit, scope and concept of the invention disclosure as defined by the appended claims.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC § 112 (1), all claims must be supported by sufficient disclosure in the present patent specification, and any material known to those skilled in the art need not be explicitly disclosed. However, 35 USC § 112 (6) requires that structures corresponding to functional limitations interpreted under 35 USC § 112 (6) must be explicitly disclosed in the patent specification. Moreover, the USPTO's Examination policy of initially treating and searching prior art under the broadest interpretation of a “mean for” or “steps for” claim limitation implies that the broadest initial search on 35 USC § 112(6) (post AIA 112(f)) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC § 112(6) (post AIA 112(f)) when such corresponding structures are not explicitly disclosed in the foregoing patent specification. Therefore, for any invention element(s)/structure(s) corresponding to functional claim limitation(s), in the below claims interpreted under 35 USC § 112(6) (post AIA 112(f)), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claim's construction proceedings and/or examination of patent allowability properly identify and incorporate only the portions of each of these documents discovered during the broadest interpretation search of 35 USC § 112(6) (post AIA 112(f)) limitation, which exist in at least one of the patents and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC § 112(6) (post AIA 112(f)), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC § 112 (6). Applicant(s) note that all the identified documents above which are incorporated by reference to satisfy 35 USC § 112 (6) necessarily have a filing and/or publication date prior to that of the instant application, and thus are valid prior documents to incorporated by reference in the instant application.

Having fully described at least one embodiment of the present invention, other equivalent or alternative methods of implementing aerospace propulsion according to the present invention will be apparent to those skilled in the art. Various aspects of the invention have been described above by way of illustration, and the specific embodiments disclosed are not intended to limit the invention to the particular forms disclosed. The particular implementation of the aerospace propulsion may vary depending upon the particular context or application. By way of example, and not limitation, the aerospace propulsion described in the foregoing were principally directed to aerospace propulsion for launcher/missile stages, upper-stages, general spacecraft propulsion, satellite maneuvering systems, deorbit, missile defense, etc. implementations; however, similar techniques may instead be applied to airplanes, jets, helicopters, etc., which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

Only those claims which employ the words “means for” or “steps for” are to be interpreted under 35 USC 112, sixth paragraph (pre-AIA) or 35 USC 112(f) post-AIA. Otherwise, no limitations from the specification are to be read into any claims, unless those limitations are expressly included in the claims.

What is claimed is:

1. A system comprising:
means for providing a Solid Controlled Rocket Engine based on a solid propellant cord;
means for feeding said propellant cord, wherein said feeding means comprise a coaxially packaged or bobbin-like structure and coupled drive system; and
means for combustion control, wherein said combustion control means is a Safety Feed Through (SFT) hardware component assembly.

2. A system comprising:
means for providing a hybrid propulsion rocket engine based on hybrid propellant, wherein said hybrid propellant is used independently or in combination with a solid system; and
means for filament feeding and coupled drive system of said hybrid propellant.

3. A Controlled Solid Propulsion System comprising:
at least one canister-built solid propellant housing configured to hold at least one solid propellant, wherein said propellant is in the form of a cord of variable length and suitable single or multiple diameters, wherein the cross-sectional area of the cord is circular or any other useful shape for thrust management purposes and the utility scope.

4. The Controlled Solid Propulsion System of claim 3 further comprising a combustion chamber and gas exhaust nozzle forming a rocket engine separate from said solid propellant housing(s).

5. The Controlled Solid Propulsion System of claim 3, wherein said solid propellant cord is packaged in a coaxial format method for easy of central-axial unrolling purposes.

6. The Controlled Solid Propulsion System of claim 3, wherein said solid propellant cord of variable length is a single diameter format or comprising multiple diameters, within the same cord, and coaxial packaging for the utility scope.

7. The Controlled Solid Propulsion System of claim 3, wherein said solid propellant cord is packaged in a bobbin/spool format or any other suitable method for easy of vertical and horizontal plane unrolling and controllable propulsion purposes.

8. The Controlled Solid Propulsion System of claim 3, wherein said canister-built housing(s) may comprise a multiple housing architecture, multidimensional, attached together and/or independently, for any suitable system size, for different combined system performances and/or the utility scope.

9. The Controlled Solid Rocket Engine of claim 4 further comprising a laser as a propellant multi-ignitions method.

10. The Controlled Solid Rocket Engine of claim 4 further comprising an associated Safety Feed Through hardware component comprising a set of grooves, engraved on at least one surface coaxially positioned with at least one solid propellant cord.

11. The Controlled Solid Rocket Engine of claim 4, wherein the combustion chamber design/hardware may be used in a dual method of utility, as a common component hardware for also hybrid rocket propulsion design purposes without major design alterations.

12. The Controlled Solid Rocket Engine of claim 10 further comprising a set of coaxially positioned jet cutters made out of said grooves through which a pressurized gas or quenching liquid is emitted perpendicularly onto said solid propellant cord as a safety feature and controlled propulsion purposes.

13. The Dual Mode Rocket Propulsion System of claim 11 further comprising a drive system for solid-cord/plastic-filament feeding.

14. The Dual Mode Rocket Propulsion System of claim 11, wherein a hybrid rocket design comprises a plastic filament, of any suitable shape, an oxidizer and said plastic filament contained in similar canister-built housing(s), also used as a common component hardware and without major design alterations.

15. The Dual Mode Rocket Propulsion System of claim 11 wherein High-Test Peroxide (HTP) may be used as a common liquid, for instantaneous hyperbolic-based solid cord grain ignition, as an oxidizer in the hybrid propulsion mode and singularly/independently, as a coupling system trimode use adding feature, for HTP monopropellant thrusters.

16. The Dual Rocket Propulsion System of claim 14, wherein a Controlled Solid Propulsion System Vehicle Architecture may be used independently or as a coupling option, through common major hardware components, with a Hybrid Propulsion Similar Vehicle Architecture, defining a Common Architecture Design.

17. The Dual Rocket Propulsion System of claim 16, wherein the Common Architecture Design may comprise Similar/Identical Vehicle Architectures in different dimensional scales for the utility scope.

18. The Dual Rocket Propulsion System of claim 17, wherein the Common Architecture Design comprises modularity and interchangeabilty feature-ability of said common hardware components.
